(19) United States
(12) Patent Application Publication
(10) Pub. No.: US 2009/0047517 A1
(43) Pub. Date: Feb. 19, 2009

(54) MULTILAYER POLYMER FILMS

(76) Inventors: Francesco Caruso, Victoria (AU); Georgina Such, Victoria (AU); Angus Johnston, Victoria (AU); Elvira Tjipto, Victoria (AU); Heng Pho Yap, Victoria (AU); Cameron Kinnane, Victoria (AU); Christopher Ochs, Victoria (AU)

Correspondence Address: HOVEY WILLIAMS LLP, 10801 Mastin Blvd., Suite 1000, Overland Park, KS, 66210, US

(21) Appl. No.: 12/147,163

(22) Filed: Jun. 26, 2008

Related U.S. Application Data
(60) Provisional application No. 60/946,604, filed on Jun. 27, 2007.

(51) Int. Cl. B01J 13/16; B32B 27/16; B05D 3/10

(52) U.S. Cl. 428/402.24; 428/420; 428/413; 427/331; 427/213.33; 427/340

(57) ABSTRACT

The invention relates to a multilayer polymer assembly comprising polymer layers covalently bonded together by crosslinks comprising a cyclic moiety, and to processes for the preparation thereof.

### RELATED APPLICATIONS

The present application claims the priority benefit of U.S. Provisional Patent Application Ser. No. 60/946,604, entitled MULTILAYER POLYMER FILMS, filed Jun. 27, 2007, incorporated by reference herein.

### FIELD OF THE INVENTION

The present invention relates to multilayer polymer assemblies, particularly covalently crosslinked multilayer polymer assemblies, to processes for the preparation of such assemblies and to core-shell particles comprising the assemblies

### BACKGROUND

Multilayer polymer materials have been prepared using a variety of different techniques. Layer-by-layer (LbL) assembly is one technique that has been used to fabricate tailored multilayer thin films of diverse composition. The majority of work in LbL assembly has focused on the construction of polyelectrolyte (PE) films by either electrostatic or hydrogen bonding interactions. Such films however can be susceptible to disassembly under varying solution conditions that disrupt the electrostatic or hydrogen bonds.

Covalently bound films offer the advantage of increased stability compared to electrostatic or hydrogen bonded films due to the presence of covalent crosslinks between layers of polymer films. However, some covalent crosslinking reactions may be limited by electrostatic, steric or thermodynamic considerations, which can adversely impact on the efficiency of covalent bond formation. In addition, covalent crosslinking reactions may require conditions such as exposure to radiation or high temperature to generate the crosslinks. Such conditions are not compatible with a number of polymeric materials.

It would be desirable to provide new covalently crosslinked multilayer polymer assemblies as well as new methods of making such assemblies.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY

It has been found that new, stable multilayer polymer materials may be afforded by using click reactions to covalently crosslink layers of polymer films assembled using a LbL approach. The present invention is applicable to the preparation of a wide variety of multilayer polymer assemblies of different composition and controlled physical properties.

In accordance with one aspect, the present invention provides a multilayer polymer assembly comprising:
(i) a plurality of polymer layers, the polymer layers forming one or more pairs of adjacent polymer layers; and
(ii) a plurality of crosslinks between at least one pair of adjacent polymer layers,
wherein each of the crosslinks comprise a cyclic moiety formed by a cycloaddition reaction.

In accordance with another aspect, the present invention provides a core-shell particle comprising a core and a shell material, wherein the shell material comprises: (i) a plurality of polymer layers, the polymer layers forming one or more pairs of adjacent polymer layers; and (ii) a plurality of crosslinks between at least one pair of adjacent polymer layers, wherein each crosslink comprises a cyclic moiety formed by a cycloaddition reaction.

In accordance with a further aspect, the present invention provides a process for the preparation of a multilayer polymer assembly comprising:
(i) providing a polymer layer;
(ii) depositing a further polymer layer to form a pair of adjacent polymer layers; and
(iii) forming a plurality of crosslinks between the pair of adjacent polymer layers, wherein each crosslink comprises a cyclic moiety formed by a cycloaddition reaction.

### BRIEF DESCRIPTION OF THE FIGURES

FIG. 1 shows a scheme illustrating the crosslinking of layer by layer (LbL) assembled polymer multilayer films using click chemistry.

FIG. 2 shows UV-vis absorption spectra for (PAA-Az/PAA-Alk) multilayer films assembled on quartz with the arrow indicating increasing bilayer number. Absorbance as a function of bilayer number at 240 nm is shown in inset.

FIG. 3 shows RAS-FTIR absorption spectra of (PAA-Az/PAA-Alk) multilayer films assembled on gold substrates with increasing bilayer number with the arrow indicating increasing bilayer number (bottom to top: bilayers 1, 2, 3, 4 and 5). Reversible change in the RAS-FTIR peak at 1700 cm⁻¹ with a change in pH for a 5-bilayer (PAA-Az/PAA-Alk) film is shown in inset.

FIG. 4 shows AFM images of (a) (PAA-Alk-PAA-Az)₄ (z scale of 10 nm) and (b) (PAA-Alk-PAA-Az)₈ multilayer films assembled on silicon (z scale of 25 nm).

FIG. 5 shows (a) fluorescence intensity of (PAA-Az/PAA-Alk)-coated silica particles as a function of layer number, as measured by flow cytometry after deposition of each PAA-Alk layer, which was fluorescently labeled with rhodamine and (b) fluorescence microscopy image of silica particles coated with (PAA-Az/PAA-Alk)₆ where the PAA-Alk is fluorescently labeled with rhodamine.

FIG. 6 shows fluorescence microscopy images of (PAA-Az/PAA-Alk)-coated silica particles functionalized with (a) Rh-Az and (b) non-specifically adsorbed Rh.

FIG. 7 shows (a) TEM and (b) AFM images of (PAA-Az/PAA-Alk)₆ capsules. The thickness of the capsule wall, determined by AFM, is ˜5 nm.

FIG. 8 shows the differential interference contrast (DIC) microscopy images of 5 μm (PAA-Az/PAA-Alk)₆ (a) core-shell particles and (b) capsules.

FIG. 9 shows fluorescence microscopy images of (PAA-Az/PAA-Alk)₆ click capsules after addition of (a) pH 2 solution and (b) pH 10 buffer and (c) a graph showing reversible pH response of the (PAA-Az/PAA-Alk)₆ capsules.

FIG. 10 shows a scheme illustrating the formation of capsules comprising click crosslinked PAA multilayers (PAA-Az/PAA-Alk).

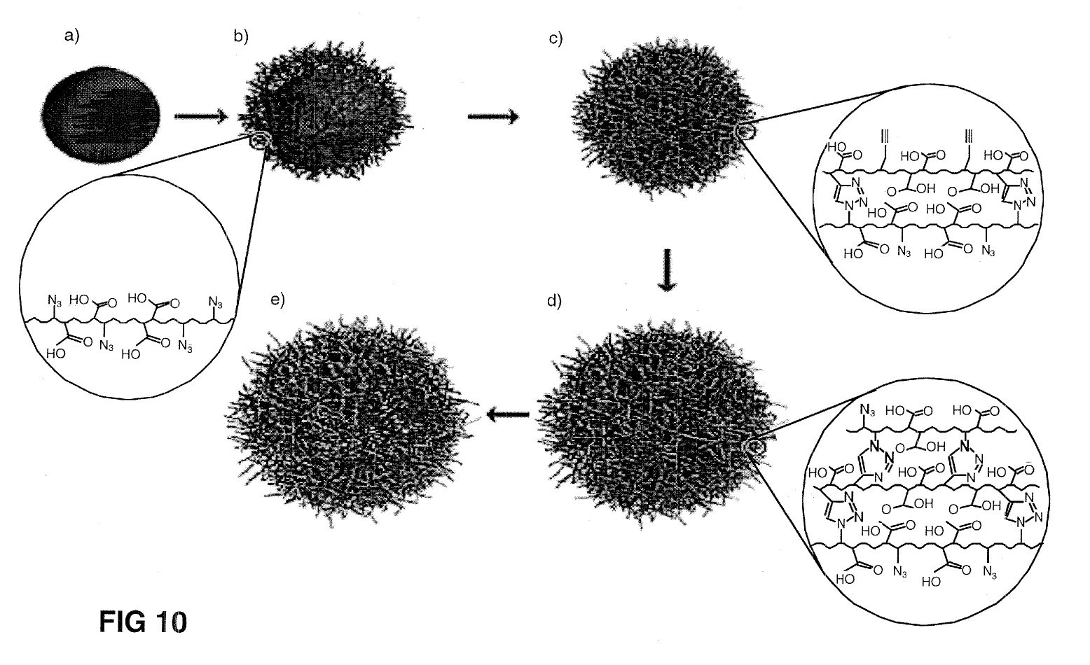

FIG. 11 shows (A) pH-responsive swelling profile and (B) reversible pH response of PAA-NPS, PAA_{B}-NPS and co-PAA-NPS and 7.5 μm MS₂₀ particles (data in squares) or 4.5 μm MS₁₀₀ templates (data in circles).

FIG. 12 is a graph illustrating a linear buildup of five PEG bilayers (PEG-Alk/PEG-Az) onto silicon wafers.

FIG. 13 shows fluorescence images of live and dead cells adhered to (a) glass, (b) (PEG-Alk/PEG-Az)₅ films and (PEG-Alk/PEG-Az)₅ films post-functionalized with (c) RGD or (d) RAD.

FIG. 14 is a graph illustrating the numbers of cells adhered to glass, PEG films, and RGD- and RAD-functionalized (PEG-Alk/PEG-Az)₅ films.

FIG. 15 shows fluorescence microscopy images of (A) PEG-MS precursors, (B) PEG_{B}-NPS, (C) DOX release of DOX-PEG-NPS in DTT after 1100 min, (D) triggered-deconstruction of DOX-PEG_{B}-NPS in physiological 5 mM GSH after 70 hr, (E) deconstruction of DOX-PEG_{B}-NPS after 340 hr, and (F) intact DOX-PEG_{B}-NPS in phosphate buffer after 340 hr, with insets corresponding fluorescence microscopy image of the respective figures.

FIG. 16 shows a three dimensionally reconstructed CLSM section of DOX-PEG_{B}-NPS, while the inset shows the reconstruction of whole DOX-PEG_{B}-NPS.

FIG. 17 shows normalized flow cytometry scattering signals of DOX-PEG_{B}-NPS in (A) 20 mg mL⁻¹ DTT, (B) 5 mM GSH and (C) phosphate buffer.

FIG. 18 shows images of (PLL-Az/PLL-Alk)₆ capsules as imaged with differential interference contrast microscopy (A), fluorescence microscopy using AF488-labeled PLL-Az (B), scanning electron microscopy (C) and atomic force microscopy (D), and images of PGA capsules as imaged with DIC (E) and fluorescence microscopy using RITC-labeled PGA-Alk (F).

FIG. 19 is a graph showing reversible pH-responsive behavior of (PLL-Az/PLL-Alk)₆ capsules after sequential addition of pH 2 (∘) and pH 11 solution (▪).

FIG. 20 shows TEM images of (A) templated PLL_{B}-MS precursor and (B-D) PLL_{B}-NPS that are (B) dispersed in milliQ solution, (C) dried and (D) dispersed in 1 M NaOH. (E) DIC image of RITC-PLL_{B}-NPS deconstructed by exposure to DTT and (F) fluorescence microscopy image of the supernatant from the RITC-PLL_{B}-NPS.

### DETAILED DESCRIPTION

Various terms that will be used throughout the specification have meanings that will be well understood by a skilled addressee. However, for ease of reference some of these terms will now be defined.

As used herein the term “layer-by-layer” refers to the sequential deposition of successive layers of polymer material in an overlapping manner.

As used herein reference to molecular weight for a polymer refers to number average molecular weight unless otherwise specified.

As used herein the terms “polyelectrolyte” or “polyelectrolyte material” refers to a material that either has a plurality of charged moieties or has the ability to carry a plurality of charged moieties. A number of polyelectrolyte materials are known in the art. Polyelectrolyte materials may be a positively charged (or have the ability to be positively charged), negatively charged polyelectrolyte (or have the ability to be negatively charged) or have a zero net charge. The term polyelectrolyte may also include macromolecules which have the ability to carry a plurality of charges, including bio-macromolecules such as such as proteins, enzymes, polypeptides, peptides, polyoligonucleotides, polysaccharides, polynucleotides, DNA, RNA and the like.

The LbL approach has conventionally been used to construct multilayered polyelectrolyte films by sequential deposition and self-assembly of oppositely charged polyelectrolyte materials. Such self-assembled structures rely on electrostatic or hydrogen bonding interactions to maintain a coherent multilayer structure. However, electrostatic and hydrogen bonds are susceptible to disruption and disassembly under varying solution conditions, which leads to destruction of the polyelectrolyte films.

Intermolecular covalent bonding between individual polymer layers of a multilayer polymer assembly can impart improved stability to the assembly by crosslinking the layers of the polymer assembly together. In the present invention, ‘click chemistry’ is used to form covalent bonds that crosslink the layers of a multilayered polymer assembly.

The term ‘click chemistry’ is used to describe covalent reactions with high reaction yields that can be performed under extremely mild conditions. A number of ‘click’ reactions involve a cycloaddition reaction between appropriate functional groups to generate a stable cyclic structure. The most well documented click reaction is the Cu(I) catalyzed variant of the Huisgen 1,3-dipolar cycloaddition of azides and alkynes to form 1,2,3-triazoles. Many click reactions are thermodynamically driven, leading to fast reaction times, high product yields and high selectivity in the reaction.

The preparation of multilayer polymer films using a combination of click chemistry and LbL assembly offers a number of significant advantages over prior techniques. Firstly, the click reactions generally proceed with high yields in mild conditions, and it is particularly efficient in water. Secondly, cyclic groups such as triazole groups, produced from the click reaction can have excellent physicochemical properties and are extremely stable to hydrolysis, oxidation or reduction. Thirdly, the click reactions are applicable to a wide range of materials, from polymers and proteins to nanoparticles, dye molecules and biological systems. Finally, the use of click chemistry to bond together individual polymer layers enables the multilayer polymer assemblies to be prepared from a single component polymer, which is not possible using conventional LbL assembly.

### Multilayer Polymer Assemblies

The present invention relates in one aspect to a multilayer polymer assembly. The polymer assembly comprises a plurality of polymer layers. The polymer layers are prepared by sequential deposition of two or more polymer layers in a LbL approach, which results in at least a portion of a polymer layer overlapping with at least a portion of another polymer layer.

The multilayer polymer assembly may comprise any number of polymer layers. In one embodiment, the assembly preferably comprises at least two polymer layers. The polymer assembly may comprise up to any maximum number of polymer layers, and the maximum number of layers may in part be dictated by the end use application of the polymer assembly. In one embodiment, the polymer assembly may comprise from between two to twelve polymer layers.

The polymer layers of the assembly may comprise any suitable polymer material. The person skilled in the art would understand that the present invention is widely applicable to a range of polymer materials and that the choice of polymer material would depend on the intended end use application. Examples of suitable polymer materials include polymers, copolymers, polyelectrolyte polymers such as poly(acrylic acid) and poly(lysine), polyethers such as polyethylene glycol, polyesters such as poly(acrylates) and poly(methacrylates), polyalcohols such as poly(vinyl alcohol), polyamides such as poly(acrylamides) and poly(methacrylamides), biocompatible polymers, biodegradable polymers, polypeptides, polynucleotides, polycarbohydrates and lipopolymers. The person skilled in the art would be able to select an appropriate polymer material suitable for an intended application. In one embodiment, the same polymer material may be used in each polymer layer. Alternatively, the polymer layers may comprise different polymer materials. The use of different polymer materials in different layers of the assembly may advantageously enable the properties of the polymer assembly to be tailored for specific applications, such as for controlled or sustained drug release applications.

In one embodiment, the polymer layers comprise a polyelectrolyte material. Examples of suitable polyelectrolyte material may comprise any suitable polyelectrolyte polymer, including but not limited to those selected from polyglycolic acid (PGA), polylactic acid (PLA), polyacrylic acid (PAA), polyamides, poly-2-hydroxy butyrate (PHB), gelatins, (A, B) polycaprolactone (PCL), poly (lactic-co-glycolic acid) (PLGA), poly(L-lysine) (PLL), poly(L-glutamic acid) (PGA), flourescently labelled polymers, conducting polymers, liquid crystal polymers, photoconducting polymers, photochromic polymers; poly(amino acids) including peptides and S-layer proteins; peptides, glycopeptides, peptidoglycans, glycosaminoglycans, glycolipids, lipopolysaccharides, proteins, glycoproteins, polypeptides, polycarbohydrates such as dextrans, alginates, amyloses, pectins, glycogens, and chitins; polynucleotides such as DNA, RNA and oligonucleotides; modified biopolymers such as carboxymethyl cellulose, carboxymethyl dextran and lignin sulfonates; polysilanes, polysilanols, poly phosphazenes, polysulfazenes, polysulfide and polyphosphate and mixtures thereof. Poly(acrylic acid) and poly(L-lysine) are particularly preferred polyelectrolyte materials. At least one polymer layer, and preferably, each polymer layer of the multilayer polymer assembly may comprise a polyelectrolyte material. In one embodiment, each polymer layer comprises a polyelectrolyte material. The polyelectrolyte materials may be of the same charge or have no charge.

In another embodiment of the invention, the polymer layers of the multilayer polymer assembly may comprise uncharged polymer materials. Preferred uncharged polymer materials are those that are compatible with biological systems. Particularly preferred polymer materials are polyethers such as poly(ethylene glycol) and uncharged polyesters such as poly(ethylene glycol acrylate). Polymers comprising ethylene glycol derived groups may be advantageous in providing a polymer assembly having low bio-fouling properties.

The material used in each polymer layer may be of any suitable size or molecular weight. In a preferred embodiment, the material used in the polymer layers has a molecular weight of at least 100, and preferably a molecular weight of 100 to 1,000,000.

The plurality of polymer layers of the multilayer polymer assembly form one or more pairs of adjacent polymer layers. The term “adjacent” is used herein to refer to a polymer layer that lies next to and preferably at least partially overlaps with another polymer layer. For example, where the multilayer polymer assembly comprises two polymer layers, the two polymer layers will be adjacent to one another and will form one pair of adjacent polymer layers. In addition, where the polymer assembly comprises three or more polymer layers, a first polymer layer will be adjacent a second polymer layer, while the second polymer layer will be adjacent to both the first polymer layer and a third polymer layer, and so on. Consequently, one pair of adjacent polymer layers is formed between the first and second polymer layers, while another pair of adjacent polymer layers is formed between the second and third polymer layers, and so on. In one embodiment adjacent polymer layers substantially overlap.

The multilayer polymer assembly of the invention comprises a plurality of crosslinks between at least one polymer layer and an adjacent polymer layer. The crosslinks each comprise a cyclic moiety formed by a cycloaddition reaction.

In one embodiment, each polymer layer of the assembly is crosslinked via a plurality of crosslinks to each polymer layer adjacent to it.

In another embodiment, at least one polymer layer of the assembly is not crosslinked to each polymer adjacent to it. In this instance, the uncrosslinked polymer layer may be bound to adjacent polymer layers by other interactions such as electrostatic or hydrogen bonding interactions, rather than by covalent bonds.

Examples of different multilayer polymer assemblies according to the invention are shown in Scheme 1:

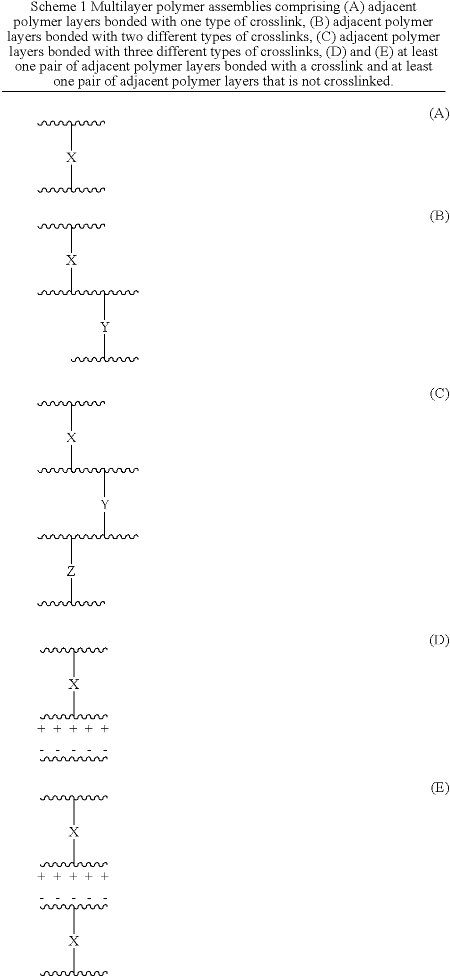

Each crosslink of the multiplayer polymer assembly may comprise any suitable cyclic moiety formed from a cycloaddition reaction. In a preferred embodiment, the cyclic moiety is selected from the group consisting of tetrazoles, triazoles and oxazoles. Preferably, the cyclic moiety is a 1,2,3-triazole. Each crosslink of the plurality of crosslinks between a pair of adjacent polymer layers may comprise the same cyclic moiety. Alternatively, the crosslinks may comprise different cyclic moieties. As a result, the plurality of crosslinks between one pair of adjacent polymer layers may comprise two or more different cyclic moieties.

In another embodiment, the plurality of crosslinks between one pair of adjacent polymer layers of the multilayer assembly may comprise a different cyclic moiety to that of the plurality of crosslinks between another pair of adjacent polymer layers. Accordingly in this embodiment, the multiplayer polymer assembly comprises two or more pairs of adjacent polymer layers, wherein the cyclic moieties of the plurality of crosslinks between one pair of adjacent polymer layers is different to the cyclic moieties of the plurality of crosslinks between another pair of adjacent polymer layers. In this regard, different pairs of adjacent polymer layers may therefore be covalently bound together by different types of crosslinks, where each type of crosslink comprises a different cyclic moiety.

The crosslinks comprising the cyclic moiety may be formed by any cycloaddition reaction known in the art. In one embodiment, the crosslinks are formed by a cycloaddition reaction involving appropriate functional groups extending from, and between, a pair of adjacent polymer layers.

The functional groups are selected from those adapted to undergo cycloaddition reactions. In this manner, the participation of the functional groups in cycloaddition reactions contributes to the formation of the plurality of crosslinks between a pair of adjacent polymer layers to covalently bond the polymer layers together. The crosslinks each comprise a cyclic moiety, which is formed by the reaction of a functional group of each of the adjacent polymer layers in the cycloaddition reaction.

The functional groups may be incorporated into the polymer material of the polymer layers by any suitable method. Suitable methods may involve the copolymerization of appropriately functionalized monomers during polymer preparation or the post-polymerization functionalisation of the polymer material. The functional groups may be present in any concentration. Preferably, the functional groups are present in an amount of from about 0.01 to 99% of the polymer. A linking group may also be present to connect the functional groups to the polymer material of the polymer layers. When the functional groups have covalently reacted in the cycloaddition reaction, the linking group becomes a part of the crosslink bonding adjacent polymer layers together.

The functional groups of the adjacent polymer layers are selected from any of those adapted to undergo cycloaddition reactions. Preferably, the functional groups are independently selected from the group consisting of alkenes, alkynes, azides, nitrites, nitrile oxides, cycloalkenes, heterocycloalkenes, maleimide, anthracene and maleic anhydride. Particularly preferred functional groups are alkynes, azides, nitriles, nitrile oxides, anthracene and maleimide. Each individual polymer layer may comprise the same type of functional groups, or they may comprise a mixture of types of functional groups. A mixture of functional groups on the same polymer layer may be advantageous where the controlled selectivity of covalent reactions is desired.

Upon covalent reaction of the functional groups of the opposed polymer layers in a cycloaddition reaction, a cyclic moiety is formed. Preferably, the cyclic moiety is selected from the group consisting of tetrazoles, triazoles and oxazoles. More preferably, the cyclic moiety is a 1,2,3-triazole. In one embodiment, the polymer layers in a pair of adjacent polymer layers may each individually comprise different types of functional groups. Where the polymer layers comprise types of different functional groups, it is preferred that the functional groups be complementary functional groups. In this sense, the term “complementary” is used to refer to those the functional groups that are capable of directly reacting with one another in the cycloaddition reaction to generate the cyclic moiety. The crosslink comprising the cyclic moiety is therefore formed as a direct result of the reaction between the different types of functional groups extending between the pair of adjacent polymer layers.

In one embodiment, the pair of adjacent polymer layers comprises a first polymer layer comprising one type of functional group and a second polymer layer comprising another type of functional group that is complementary to the functional groups of the first polymer layer. In one embodiment, the first polymer layer comprises alkyne functional groups while the second polymer layer comprises azide functional groups. The alkyne and azide functionalities react with each other in the variant of the Huisgen 1,3-dipolar cycloaddition to form a 1,2,3-triazole moiety, which covalently bonds the first and second polymer layers together. The person skilled in the art would appreciate that the order to the arrangement of the functionalities may be reversed, that is, the first polymer layer may comprise the azide functionalities while the second polymer layer may comprise the alkyne functionalities, and still obtain the same 1,2,3-triazole moiety. An example of the covalent cycloaddition reaction of complementary functional groups to form crosslinks in the polymer assembly is shown in Scheme 2:

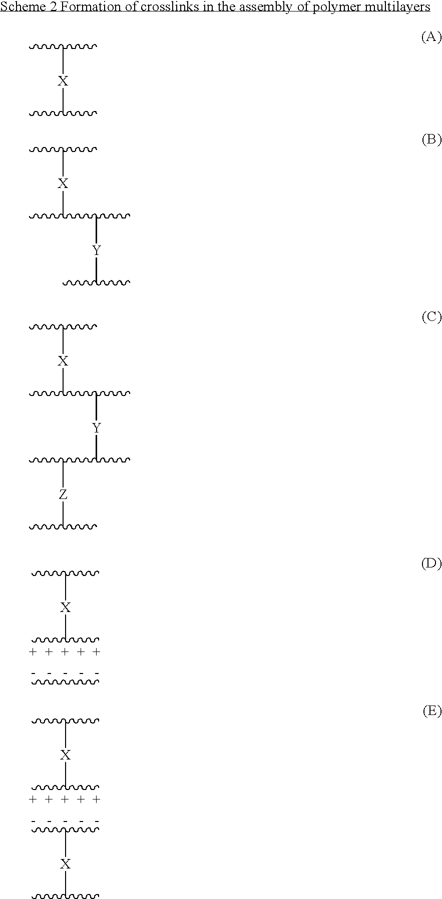

Other complementary functional groups may be paired in similar manner between adjacent polymer layers in order to from the crosslink comprising the cyclic moiety. In addition to the alkyne-azide functional pair, examples of other complementary paired functional groups are alkyne-nitrile oxide, nitrile-azide and maleimide-anthracene. Each of the paired complementary functional groups gives rise to cyclic moieties when they directly react with one another in a covalent cycloaddition reaction. The person skilled in the art would be able to select other functional group pairings capable of participating in cycloaddition reactions that satisfy the requirements of click chemistry. Some examples are described in Macromolecular Rapid Communications 2007, 28, 15-54, the disclosure of which is incorporated herein by reference.

In another embodiment, the polymer layers of a pair of adjacent polymer layers may each comprise the same type of functional groups. In this instance, the functional groups may not be capable of directly reacting with one another to generate the crosslink. Accordingly in this embodiment, a crosslinking agent may be used to covalently react with the functional groups of the adjacent polymer layers in a cycloaddition reaction, to from the crosslink comprising a cyclic moiety. Thus the crosslinks are formed by a cyclocaddition reaction between functional groups the pair of adjacent polymer layers and a crosslinking agent.

The crosslinking agent comprises at least two reactive groups adapted to undergo cycloaddition reactions with the functional groups of the polymer layers. The crosslinking agent may comprise any number of reactive groups, however it is preferred that the crosslinking agent comprise two reactive groups. Any suitable crosslinking agent of appropriate composition may be used provided that the functional groups of the crosslinking agent are complementary to the functional groups of each of the adjacent polymer layers. The complementary arrangement of the functional groups of the polymer layers and crosslinking agent is such that when the crosslinking agent is reacted with the respective functional groups of the each polymer layer in a pair of adjacent polymer layers, a cyclic moiety is formed between the crosslinking agent and the respective polymer layers.

The functional groups of the crosslinking agent and the adjacent polymer layers are selected from those adapted to undergo cycloaddition reactions with the functional groups of the adjacent polymer layers. Preferably, the adjacent polymer layers and the crosslinking agent each comprise functional groups independently selected from the group consisting of alkenes, alkynes, azides, nitriles, nitrile oxides, cycloalkenes, heterocycloalkenes, maleimide, anthracene and maleic anhydride. Particularly preferred reactive groups are alkynes, azides, nitrites, nitrile oxides, anthracene and maleimide.

Where a pair of adjacent polymer layers each comprise the same type of functional group, the crosslinking agent will preferably also comprise complementary functional groups having the same type of functionality. As an example, where the polymer layers each comprise alkyne functional groups, the crosslinking agent may therefore comprise azide functionalities as the corresponding complementary reactive groups. The alkyne and azide functionalities of the polymer layers and the crosslinking agent respectively, may then covalently react in a cycloaddition reaction to form the crosslink between the polymer layers.

In a further embodiment of the invention, where the pair of adjacent polymer layers comprises different types of functional groups, a crosslinking agent may also be employed to covalently bond the polymer layers together. In this embodiment, the functional groups of the crosslinking agent would be of differential functionality, and each functional group of the crosslinking agent would be complementary with a respective functional group of a selected polymer layer. As an example, where a first polymer layer comprises azide functional groups and a second polymer layer comprises alkyne functional groups, a crosslinking agent having both azide and alkyne reactive groups may be used. Where a crosslinking agent comprising at least two different types of functional groups is used, one of the types of functional group may be selectively protected using an appropriate protecting group in order to avoid undesired reactions occurring with the selected functional group. The protecting group may then be removed prior to the desired cycloaddition reaction to form the crosslink.

In addition to the functional groups described, the pair of adjacent polymer layers may also comprise other functional groups, such as carboxylic functional groups, as seen in Scheme 3. These functional groups typically do not participate in the cycloaddition reactions that covalently bond the polymer layers, and remain within the multilayer polymer assembly. The additional functional groups may be introduced by any method known in the art. For example, the functional groups may be present within the polymer material of a given polymer layer, or they may be introduced by modification of the polymer material. Such functional groups may be useful to impart a charge to the polymer assembly or for further functionalisation of the polymer assembly.

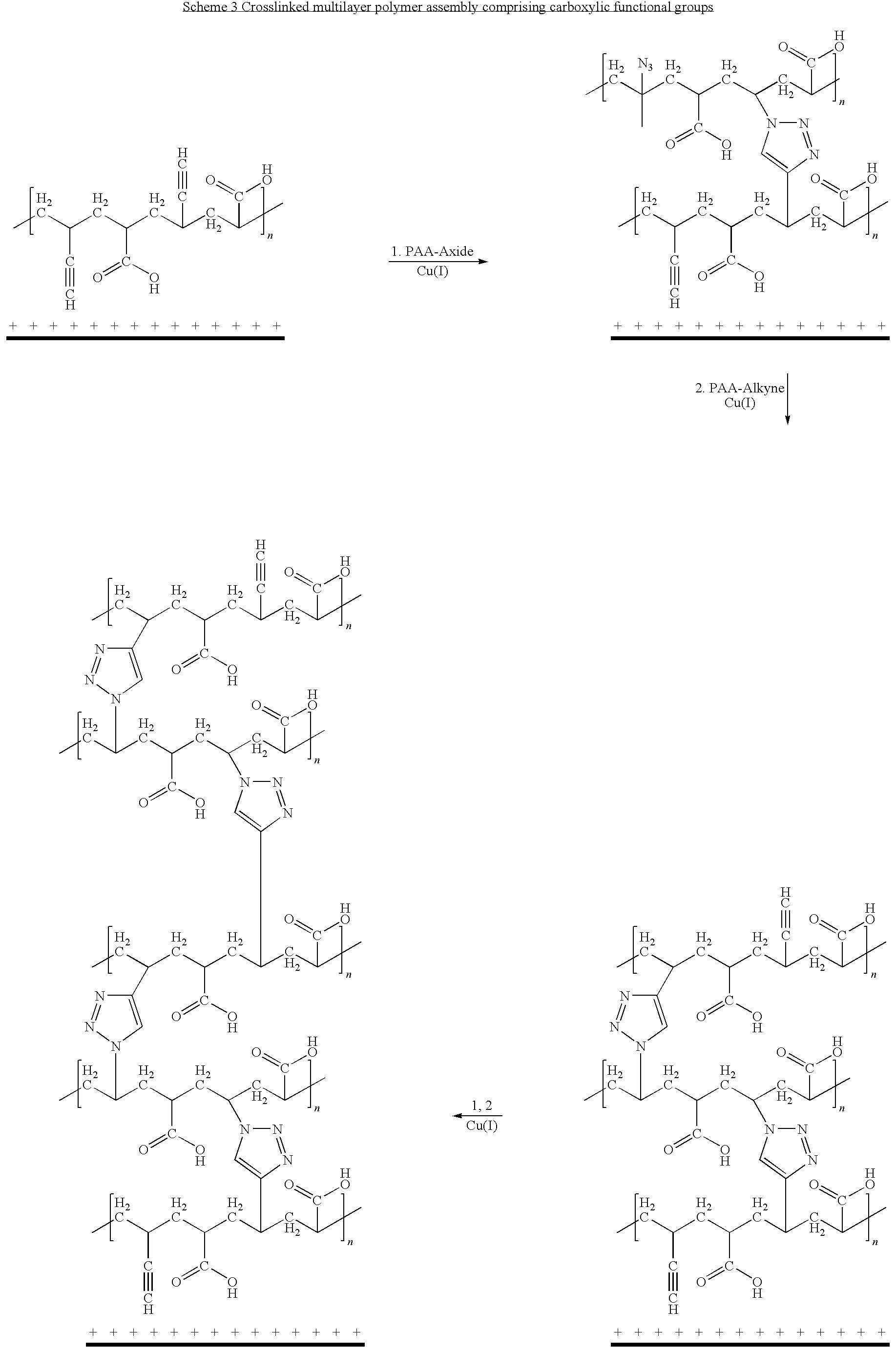

In one embodiment of the invention, the crosslinks of the multilayer polymer assembly may comprise a cleavable moiety which is adapted to undergo selective degradation under pre-determined conditions. The cleavable moiety may be any suitable moiety that undergoes selective degradation. Preferably, the cleavable moiety degrades under hydrolytic, thermal, enzymatic, proteolytic or photolytic conditions. In a preferred embodiment, the cleavable moiety is selected from the group consisting of a disulfide, an ester, an amide, a photocleavable link and bio-fragments such as proteins. The cleavable moiety may be introduced by a crosslinking agent that has covalently reacted with the functional groups of the opposed polymer layers. An example of a crosslinking agent comprising a cleavable moiety is bis[b-(4-azidosilicylamido)ethyl]disulfide, which contains azido functional groups adapted to covalently react with alkyne functional groups in opposed polymer layers, and a disulfide linkage which is able to undergo selective degradation under defined conditions. It would be appreciated that other crosslinking agents, comprising other reactive functional groups and cleavable moieties, may be also used.

In another embodiment, the cleavable moiety may be present in a linking group that is used to connect the functional group to the polymer material of a polymer layer. As described above, the linking groups become a part of the crosslink once the functional groups of the adjacent polymer layers have reacted in a cycloaddition reaction. The degradation of the cleavable moiety provides a convenient route for the selective disassembly of the multilayer polymer structure under controlled conditions.

### Process for Preparation of Multilayer Polymer Assembly

In accordance with another aspect of the invention there is provided a process for the preparation of a multilayer polymer material. The process of the invention utilizes a layer-by-layer (LbL) approach of depositing successive polymer layers to construct the polymer assembly. The present invention offers particular appeal for systems that cannot be fabricated using traditional LbL assembly, such as non-charged, non H-bonding polymers. Further, it is particularly well suited to biological systems as a result of the extremely mild reaction conditions employed to covalently bond the polymer layers.

In accordance with one aspect, the present invention relates to a process for the preparation of a multilayer polymer assembly comprising:

(i) providing a polymer layer;
(ii) depositing a further polymer layer to form a pair of adjacent polymer layers; and
(iii) forming a plurality of crosslinks between the pair of adjacent polymer layers, wherein each crosslink comprises a cyclic moiety formed by a cycloaddition reaction.

The provision of a polymer layer in the first step of the process may be achieved by any suitable method. In one embodiment, the provision of the polymer layer is achieved by forming the polymer layer on a substrate. The polymer layer may be bound to the substrate by covalent, electrostatic or hydrogen bonding interactions. Any suitable substrate may be used. In one embodiment, the substrate is a planar substrate. In another embodiment, the substrate is a particulate template. Examples of particulate templates include colloidal particles, nanoparticles, microspheres, crystals, and the like. A preferred particulate template is a colloidal particle. The substrate may comprise any suitable material. Preferably, the substrate comprises a material selected from the group consisting of silicon, gold, quartz, polymeric materials such a degradable polymer, for example, polyesters and silica. The substrate may also be provided by micelles, emulsion droplets, air, bubbles or any other surface or material that provides a phase interface. The substrate may be optionally coated with a coating material. An example of a suitable coating material is polyethyleneimine (PEI). The substrate may also be optionally modified to enhance its interaction with the polymer layer. For example, functional groups (e.g. halogen groups) present on the surface of a substrate may be exchanged for azide groups which are then able to covalently react with an alkyne functionalized polymer layer in a cycloaddition reaction to bond the polymer layer to the substrate.

In one embodiment, the substrate is removable. In this regard, the substrate may be removed by exposing the substrate to appropriate conditions that destroy the substrate but do not adversely affect the polymers used in the preparation of the assembly. In one embodiment, the substrate is removed by exposure to hydrofluoric acid. It is preferred that the hydrofluoric acid has a concentration of from 0.01 to 10 M, more preferably from 1 to 10 M, most preferably about 5 M. The substrate may also be removed by disrupting any covalent, electrostatic or hydrogen bonding interactions between the substrate and the polymers used in the preparation of the multilayer assembly, and thereafter liberating the substrate from the polymers.

The substrate may be dipped into the solution comprising the polymer material to form the polymer layer on the substrate. In this manner, the polymer material is dispersed as a layer on the substrate. The person skilled in the art would appreciate that other methods may be used to form the polymer layer. Where the substrate is a particulate template, the polymer solution may be dispersed on the surface of the template to provide a polymer layer that typically surrounds the entire template. The polymer solution may comprise the polymer material in any suitable concentration. Typically, the solution may have a concentration of the polymer material from about 0.001 to 100 mg mL⁻¹, more preferably from about 0.1 to 30 mg mL⁻¹, most preferably from 0.5 to 10 mg mL⁻¹.

The process of the invention then involves the step of depositing a further polymer layer to form a pair of adjacent polymer layers. The further polymer layer may be deposited using any suitable technique. In one embodiment, the further polymer layer may be deposited by contacting a substrate carrying a polymer layer with a solution comprising a suitable polymer material. In a preferred embodiment, the substrate carrying the polymer layer is dipped into a solution comprising a polymer material to deposit the further polymer layer and thereby form a pair of adjacent polymer layers.

After deposition of the further polymer layer, the mixture thus formed is typically incubated to allow the further polymer layer to be adsorbed. This can be done for any suitable length of time but it is typically found that the solution is incubated from 15 minutes to 24 hours, more preferably from 2 hours to 20 hours, even more preferably from 4 hours to 12 hours, most preferably about 6 hours. During incubation, the solution may also be agitated to assist in the deposition of the further polymer layer.

The process of the invention subsequently involves the step of forming a plurality of crosslinks between adjacent polymer layers, wherein each crosslink comprises a cyclic moiety formed by a cycloaddition reaction. Each crosslink may comprise any suitable cyclic moiety formed from a cycloaddition reaction. In a preferred embodiment, each crosslink may comprise a cyclic moiety independently selected from the group consisting of tetrazoles, triazoles and oxazoles. Preferably, the cyclic moiety is a 1,2,3-triazole. Each crosslink of the plurality of crosslinks between the adjacent polymer layers may comprise the same cyclic moiety. Alternatively, the crosslinks may comprise different cyclic moieties.

The crosslinks comprising the cyclic moiety may be formed by any cycloaddition reaction known in the art. Typically, the crosslinks are formed by a cycloaddition reaction involving appropriate functional groups extending from, and located between, the adjacent polymer layers.

The functional groups of the polymer layers may be selected from any of those adapted to undergo cycloaddition reactions. Preferably, the functional groups are independently selected from the group consisting of alkenes, alkynes, azides, nitrites, nitrile oxides, cycloalkenes, heterocycloalkenes, maleimide, anthracene and maleic anhydride. Particularly preferred functional groups are alkynes, azides, nitrites, nitrile oxides, anthracene and maleimide.

As discussed above, the functional groups of the polymer layers may be introduced by incorporating appropriate functionalities into the polymer material used to prepare the polymer layers. The introduction of the functional groups may be achieved using any technique, such as through the copolymerization of appropriately functionalized monomers during preparation of the polymer material or by post-polymerization functionalisation of the polymer material. The functional groups may be present in any concentration. In one embodiment, the functional groups are present in an amount of from about 0.01 to 99% of the polymer. A linking group may also be present to connect the functional groups to the polymer material of the polymer layers. The linking group becomes a part of the crosslink bonding adjacent polymer layers together once the functional groups have reacted to form the crosslink.

In one embodiment, the plurality of crosslinks is formed by a cycloaddition reaction between complementary functional groups extending from the pair of adjacent polymer layers. In this regard, the polymer layers in the pair of adjacent polymer layers may each individually comprise different types of functional groups, which are complementary to each other and are capable of directly covalently reacting with one another in a cycloaddition reaction to form the crosslink comprising the cyclic moiety in between the polymer layers. As an example, a first polymer layer may have alkyne functional groups while an adjacent second polymer layer has azide functional groups. The alkyne and azide functionalities react with each other in the variant of the Huisgen 1,3-dipolar cycloaddition to form a 1,2,3-triazole moiety, which covalently bonds the first and second polymer layers together. In addition to the alkyne-azide functional pair, the pair of adjacent polymer layers may comprise other complementary paired functional groups capable of participating in click reactions. Examples of other complementary pairs of functional groups include alkyne-nitrile oxide, nitrile-azide and maleimide-anthracene.

In another embodiment, the plurality of crosslinks is formed by a cycloaddition reaction between functional groups extending from the pair of adjacent polymer layers and a crosslinking agent. This may be desirable where the adjacent polymer layers each have the same type of functional groups. When a crosslinking agent is used, the crosslinking agent comprises at least two reactive functional groups.

In one embodiment, the crosslinking agent may covalently react with the functional groups of each polymer layer in the pair of adjacent polymer layers in a cycloaddition reaction to thereby form the crosslink comprising a cyclic moiety. The functional groups of the crosslinking agent are therefore complementary with the functional groups of each of the adjacent polymer layers. As an example, where the polymer layers each comprise alkyne functional groups, the crosslinking agent may therefore comprise azide functionalities as the corresponding complementary reactive groups. The alkyne and azide functionalities of the polymer layers and the crosslinking agent respectively covalently react in a cycloaddition reaction to form the crosslink between the polymer layers.

In another embodiment, at least one of the functional groups of the crosslinking agent is adapted to undergo cycloaddition reactions with the functional groups of one of the pair of adjacent polymer layers, while the remaining functional groups of the crosslinking agent participate in different covalent bonding interactions with functionalities present in the other polymer layer of the pair of adjacent polymer layers.

Preferably, the crosslinking agent comprises at least two functional groups, wherein each functional group is adapted to undergo cycloaddition reactions. Preferably, the functional groups of the crosslinking agent are independently selected from the group consisting of alkenes, alkynes, azides, nitriles, nitrile oxides, cycloalkenes, heterocycloalkenes, maleimide, anthracene and maleic anhydride. Particularly preferred functional groups are alkynes, azides, nitriles, nitrile oxides, anthracene and maleimide.

In one embodiment, the crosslinking agent is of general formula (I)

Y-Q2-Z (I)

where
Q2 is a linking group, and
Y and Z are functional groups that may be the same or different, and at least one of Y and Z is selected from the group consisting of alkenes, alkynes, azides, nitrites, nitrile oxides, cycloalkenes, heterocycloalkenes, maleimide, anthracene and maleic anhydride.

In another embodiment the adjacent polymer layers and the crosslinking agent each comprise functional groups independently selected from the group consisting of alkenes, alkynes, azides, nitrites, nitrile oxides, cycloalkenes, heterocycloalkenes, maleimide, anthracene and maleic anhydride, wherein the functional groups of the crosslinking agent are complementary with the functional groups of the adjacent polymer layers.

The plurality of crosslinks between one pair of adjacent polymer layers of the multilayer assembly may comprise a different cyclic moiety to that of the plurality of crosslinks between another pair of adjacent polymer layers. Accordingly, where the multiplayer polymer assembly comprises two or more pairs of adjacent polymer layers, the cyclic moieties of the plurality of crosslinks between one pair of adjacent polymer layers may be different to the cyclic moieties of the plurality of crosslinks between another pair of adjacent polymer layers. In this regard, different pairs of adjacent polymer layers may therefore be covalently bound together by different types of crosslinks, where each type of crosslink comprises a different cyclic moiety.

The plurality of crosslinks may comprise a cleavable moiety adapted to undergo selective degradation under pre-determined conditions. Preferably, the cleavable moiety is selected from the group consisting of a disulfide, an ester, an amide, a photocleavable link and bio-fragments such as proteins. The cleavable moiety may be provided by a crosslinking agent or alternatively, it may be provided by a linking group that is used to connect the functional group to the polymer material of a polymer layer. As discussed above, the linking group forms part of the crosslink once the functional groups of the adjacent polymer layers have reacted in a cycloaddition reaction.

In one embodiment the crosslinking agent of Formula (I) may comprise a cleavable moiety. As such, the linking group Q2 may comprise at least one moiety selected from the group consisting of a disulfide, an ester, an amide, a photocleavable link and bio-fragments such as proteins. Preferably Q2 comprises a disulfide moiety. An example of a crosslinking agent comprising a cleavable disulfide moiety is bis[b-(4-azidosilicylamido)ethyl]disulfide. The presence of the cleavable moiety means that a triggered release mechanism, which is activated under specified conditions, may be engineered in the multilayer polymer assembly. This triggered release mechanism may be useful in applications where controlled release of an entity is desired such as for example, in targeted drug release applications.

The cycloaddition reactions are preferably performed in the presence of a catalyst, which enhances the rate of the reaction. Preferably, the catalyst is a metal catalyst. In one embodiment the metal catalyst comprises a metal selected from the group consisting of Au, Ag, Hg, Cd, Zr, Ru, Fe, Co, Pt, Pd, Ni, Cu, Rh and W. More preferably, the metal catalyst comprises a metal selected from the group consisting of Ru, Pt, Ni, Cu and Pd. Even more preferably, the catalyst comprises Cu(I). The presence of a catalyst however is not essential, and the covalent reaction may be performed in the absence of a catalyst. The use of high temperature or pressure reaction conditions or irradiation such as by microwaves, may eliminate the need to use a catalyst.

The multilayer polymer assembly thus formed in accordance with the process of the invention comprises at least two polymer layers. In its simplest form, the multilayer assembly comprises only two polymer layers. However, the person skilled in the art that would appreciate that the multilayer assembly may comprise any number of polymer layers. Theoretically, there is no upper limit to the number of polymer layers in the multilayer assembly, although for some practical purposes, the assembly may comprise from between two and ten polymer layers.

If it is desired for the multilayer polymer assembly to comprise more than two polymer layers, one or more further polymer layers may be subsequently deposited. Accordingly, the process of the invention may comprise a further step of depositing a polymer layer. The polymer layer may be deposited by any suitable process.

In one embodiment the process of the invention further comprises the step of:
(iv) depositing a polymer layer by a process selected from the group consisting of:
   (a) depositing a polymer to form a pair of adjacent polymer layers, and forming a plurality of crosslinks between the pair of adjacent polymer layers, wherein each crosslink comprises a cyclic moiety from by a cycloaddition reaction; and
   (b) depositing a polymer layer, wherein said polymer layer is not subsequently crosslinked to the polymer layer it is deposited on.

In one embodiment, the polymer layer is deposited by a process selected from the group consisting of: (a) depositing a polymer layer to form a pair of adjacent polymer layers, and forming a plurality of crosslinks between the pair of adjacent polymer layers, where each crosslink comprises a cyclic moiety formed by a cycloaddition reaction; and (b) depositing a polymer layer, wherein said polymer layer is not crosslinked to the polymer layer it is deposited on. The further step (iv) of depositing a polymer layer may be repeated a plurality of times, depending on the number of polymer layers desired in the final assembly. In this regard, the person skilled in the art would understand that the process of the invention allows successive polymer layers to be deposited in the construction of the multilayer polymer assembly using a layer by layer approach, to form additional pairs of adjacent polymer layers.

In process (a), the polymer layer is deposited on an existing polymer layer of the assembly to form a pair of adjacent polymer layers and crosslinked. The crosslinking may be performed prior to the deposition of a succeeding polymer layer. Alternatively, a plurality of further polymer layers may be firstly deposited, then crosslinked.

In process (b), the polymer layer is not crosslinked to the polymer layer it is deposited on. In a preferred embodiment, the further polymer layer may be bound to the polymer layers adjacent to it by other interactions, such as electrostatic or hydrogen bonds.

Preferred processes (a) and (b) as described above for the further deposition of polymer layers may be performed in any order during the construction of the multilayer polymer assembly. Accordingly, the further deposition of the plurality of polymer layers may proceed by depositing the polymer layers in accordance with process (a) followed by process (b), or vice-versa. In addition, each of process (a) and (b) may be repeated a plurality of times in any order. In this manner, the multilayer polymer assembly may therefore comprise a combination of crosslinked and uncrosslinked polymer layers. Furthermore, either of process (a) or process (b) may be used alone to further deposit polymer layers, and each of process (a) or process (b) may be repeated a plurality of times.

The further deposition of a polymer layer may be achieved using any suitable technique. Preferably, the further deposition is achieved by contacting a substrate carrying the polymer layers with successive solutions comprising a polymer material, such as by dipping. After the further deposition of each polymer layer, the assembly thus formed may be typically incubated to allow the polymer layers to be adsorbed. This can be done for any suitable length of time but it is typically found that the solution is incubated from 15 minutes to 24 hours, more preferably from 2 hours to 20 hours, even more preferably from 4 hours to 12 hours, most preferably about 6 hours. During incubation, the solution may also be agitated to assist in the deposition of the polymer layer. In this manner, several polymer layers may be assembled together in a layer-by-layer approach. The person skilled in the art would recognize that in theory any number of further polymer layers may be deposited, and that the total number of polymer layers may depend on the end use of the polymer assembly. In a one embodiment, from two to twelve further polymer layers are deposited. The growth of the polymer layers in the multilayer polymer assembly, including the thickness of the layers, may be monitored using any suitable technique. Examples of suitable techniques include UV-vis and IR spectroscopy, ellipsometry and atomic force microscopy.

Any suitable polymer material may be used to prepare the polymer layers. The person skilled in the art would understand that the present invention is widely applicable to a range of polymer materials and that the choice of polymer material would depend on the intended end use application. Examples of suitable polymer materials include polymers, copolymers, polyelectrolyte polymers such as poly(acrylic acid) and poly(lysine), polyethers such as polyethylene glycol, polyesters such as poly(acrylates) and poly(methacrylates), polyalcohols such as poly(vinyl alcohol), polyamides such as poly(acrylamides) and poly(methacrylamides), biocompatible polymers, biodegradable polymers, polypeptides, polynucleotides, polycarbohydrates and lipopolymers. In one embodiment, the same polymer material is used in each individual polymer layer. Alternatively, the polymer layers may comprise different polymer materials.

The polymer material may be dissolved in a suitable solvent to form a solution comprising the material. The solution may then used to form polymer layers in a LbL approach.

In a one embodiment, a polyelectrolyte material is used to prepare the polymer layers. The polyelectrolyte material may be comprise any suitable polyelectrolyte polymer, including but not limited to those selected from the group consisting of polyglycolic acid (PGA), polylactic acid (PLA), polyacrylic acid (PAA), polyamides, poly-2-hydroxy butyrate (PHB), gelatins, (A, B) polycaprolactone (PCL), poly (lactic-co-glycolic acid) (PLGA), poly(L-lysine) (PLL), poly(L-glutamic acid) (PGA), flourescently labelled polymers, conducting polymers, liquid crystal polymers, photoconducting polymers, photochromic polymers; poly(amino acids) including peptides and S-layer proteins; peptides, glycopeptides, peptidoglycans, glycosaminoglycans, glycolipids, lipopolysaccharides, proteins, glycoproteins, polypeptides, polycarbohydrates such as dextrans, alginates, amyloses, pectins, glycogens, and chitins; polynucleotides such as DNA, RNA and oligonucleotides; modified biopolymers such as carboxymethyl cellulose, carboxymethyl dextran and lignin sulfonates; polysilanes, polysilanols, poly phosphazenes, polysulfazenes, polysulfide and polyphosphate or a mixture thereof. Poly(acrylic acid) and poly(L-lysine) are particularly preferred polyelectrolyte materials. At least one polymer layer, and preferably, each polymer layer of the multilayer polymer assembly may comprise a polyelectrolyte material. In a one embodiment, each polymer layer comprises a polyelectrolyte material of the same charge or no charge.

In another embodiment, uncharged polymer materials are used in the polymer layers. Preferred uncharged polymer materials are those that are compatible with biological systems. Particularly preferred polymer materials are polyethers such as poly(ethylene glycol) and uncharged polyesters such as poly(ethylene glycol acrylate).

The polymer material used to form the polymer layers may be of any suitable size or molecular weight. It is preferred that the material used in each polymer layer have a molecular weight of at least 100, and preferably a molecular weight of 100 to 1,000,000.

The multilayer polymer assembly prepared in accordance with the present invention may possess free functional groups. The free functional groups occur as not all the functional groups that are present in the polymer layers participate in cycloaddition reactions to form crosslinks between the polymer layers. The free functional groups may be used to modify the polymer assembly with other compounds or materials, such as polymers, biomacromolecules, or other functional compounds to thereby enhance the ability to use the polymer assemblies in a range of applications, by the use of click reactions. This may be achieved by further reacting at least one functional group of a polymer layer with a modifying compound that comprises a complementary ‘click’ functional group that is adapted to undergo a cycloaddition reaction with the functional group of the polymer layer.

Thus in another embodiment, the process of the present invention further comprises the step of modifying the multilayer polymer assembly by reacting at least one functional group of the polymer assembly with at least one compound selected from the group consisting of antifouling agents, antimicrobials, chelating compounds, fluorescent compounds, antibodies, scavenging compounds, proteins and peptides (such as extracellular matrix proteins and peptides) and physiologically active compounds. Such compounds would generally comprise a complementary functional group adapted to undergo a cycloaddition reaction with the functional group of the polymer layer. The compounds may modify the surface of the polymer assembly, or may infiltrate the layers of the polymer assembly and react with functional groups within the polymer assembly.

In one embodiment the multilayer polymer assembly is modified with a peptide. Preferably, the peptide is a cell adhesion promoting peptide sequence, such as arginine-glycine-asparate (RGD). The tripeptide RGD is useful as it can promote the adhesion and subsequent survival and proliferation of many cells.

In another embodiment the multilayer polymer assembly is modified with an anti-fouling agent. Preferably the anti-fouling agent resists fouling by biological material. A preferred anti-fouling agent is poly(ethylene glycol) (PEG). Poly(ethylene glycol) may help to create a low fouling surface on the polymer assembly. In one embodiment the poly(ethylene glycol) may be substituted with other compounds to allow specific interactions to occur. For example, the PEG may be optionally substituted with an active moiety that binds with a physiologically active compound. This could enable the multilayer polymer assembly to exhibit both low fouling and bio-targeting properties at the same time. An example of a substituted PEG is PEG-Biotin, where the biotin moiety attached to the PEG enables specific binding with streptavidin.

The ability to modify the multilayer polymer assembly with such compounds is useful given that click chemistry is a simple technique performed under mild conditions with high efficiency, making it broadly compatible with biological systems. This would permit biofunctionalization of the multilayer polymer assemblies for application in areas such as targeted drug delivery, biosensing, biocatalysis and for the promotion of biological responses such as cell adhesion and/or cell growth in applications such as tissue engineering.

### Core-Shell Particles

When the multilayer polymer assembly of the invention is formed on a particulate template, such as a colloidal particle, as a substrate, a core-shell particle may be formed. In this instance, the particulate template assists to define the core while the shell is comprised of a multilayer polymer assembly.

Thus in another aspect of the invention there is provided process for the preparation of a core-shell particle comprising a core and a shell material, the process comprising the steps of (a) providing a particulate template and (b) forming a shell material comprising a multilayer polymer assembly on the particulate template, wherein the multilayer polymer assembly comprises: (i) a plurality of polymer layers, the polymer layers forming one or more pairs of adjacent polymer layers; and (ii) a plurality of crosslinks between at least one pair of adjacent polymer layers, and wherein each crosslink comprises a cyclic moiety formed by a cycloaddition reaction. The formation of the multilayer polymer assembly may be achieved by the process of the invention as described herein.

The particulate template used to prepare the core-shell particle may comprise any suitable material and be of any suitable form. Examples of particulate templates include colloidal particles, nanoparticles, microspheres, crystals, and the like. A preferred particulate template is a colloidal particle. Examples of suitable materials include silicon, gold, quartz, polymeric materials and silica. A preferred material is silica. The particulate template may also be of any suitable size and form. It is most preferred that the particulate template produces a spherical or substantially spherical core-shell particle. It will be convenient to describe the invention in terms of a spherical material, but it shall be kept in mind that the core-shell particle produced by the process of the invention may be of any form, depending on the form of the particulate template used. Thus in general the final shape of the core-shell particles produced by the process of the invention will take the general shape or form of the particulate template used in their synthesis. Thus for example if the template is spherical then the final product will typically be spherical. In one aspect of the invention, the particulate template is a solid particle.

In another aspect of the invention, the particulate template is a porous particle. The porous particle may be used to provide core-shell particles having an interconnected network of pores. The pores may take a number of different shapes and sizes however it is preferred that the porous particle is a mesoporous template. Mesoporous templates are templates in which there are at least some pores, preferably a majority of pores having a pore size in the range 2 to 50 nm. The mesoporous template may be made of a number of suitable materials. In a preferred embodiment, the mesoporous template is made of a material that allows for its subsequent removal, such as for example a mesoporous silica material. In general, the mesoporous silica material may have a bimodal pore structure, that is, having smaller pores of about 2-3 nm and larger pores from about 10-40 nm. The template may take any suitable form and may be for example in the form of powder particles or spheres. It is preferred that the template is spherical or substantially spherical.

Where a porous particle is used as a particulate template porous core-shell materials may be formed. The pores are formed in the core-shell material as a result of the ability to construct the multilayer polymer assembly within the pores of the particulate template. It is a preferred embodiment of the invention that the porous particulate template be removal in order to form a hollow core-shell particle having a porous structure. The pores in the core-shell material may be of a wide variety of sizes however the material preferably includes pores with a pore size of from 5 to 50 nm, even more preferably 10 to 50 nm. In a particularly preferred embodiment the pores of the core-shell material are interconnecting to produce an interconnected porous network. It is an advantage of the invention that the porous core-shell particles of the invention are self-supporting in that the pores do not collapse under the weight of the polymer material after template removal.

In addition, where a porous particle is used, the exposed surface of the pores of a porous particulate template may be modified prior formation of the core-shell particle to enhance the interaction of the particulate template with the polymer layers of the multilayer polymer assembly in the shell material. An example of a suitable process to modify the pores of the porous particulate template is described in International patent application no PCT/AU2005/001511 (WO2006/037160), the disclosures of which is herein incorporated by reference. A skilled worker in the area will generally have little difficulty in choosing a functional moiety to introduce onto the pores of the colloidal particle to complement the first polymer layer deposited onto the porous particulate template to form the shell material.

In each of the above aspects, the particulate template may be removable. The person skilled in the art would understand that the ability to remove the template would depend upon the nature of the template material. It is an aspect of the invention that the template is capable of being removed from the core of the core-shell material under conditions that do not disrupt the multilayer polymer assembly that constitutes the shell material. A range of removable particulate templates would be known the person skilled in the art. A preferred removal particulate template is a silica particle. The removal of the particulate template from the core gives rise to a core-shell material having a hollow core. The hollow core-shell particles may be regarded as nanoparticles or capsules. The removal of the particulate template may be carried out by any suitable method and the person skilled in the art would understand that the method would depend upon the nature of the particulate template and/or the shell material of the core-shell particle. Preferably, the removal of the particulate template is carried out by exposure to hydrofluoric acid. It is preferred that the hydrofluoric acid has a concentration of from 0.01 to 10 M, more preferably from 1 to 10 M, most preferably about 5 M.

In another aspect of the invention there is provided a core-shell particle comprising a core and a shell material, wherein the shell material comprises: (i) a plurality of polymer layers, the polymer layers forming one or more pairs of adjacent polymer layers; and (ii) a plurality of crosslinks between at least one pair of adjacent polymer layers, wherein each crosslink comprises a cyclic moiety formed by a cycloaddition reaction.

The core may be a hollow core. In this instance, the core-shell particle may therefore be a hollow nanoparticle or capsule.

The core-shell particle may also be a porous particle. Preferably, the porous particle is a nanoporous capsule comprising a hollow core.

### Applications

The multilayer polymer assemblies of the invention are stable and robust systems that may be used in a variety of applications, including biomaterials, drug delivery, chelating, targeting, anti-fouling, scavenging and bio-sensing applications.

Depending on the nature of the polymer material used to prepare the multilayer assembly, a range of useful physical characteristics may be obtained. As an example, multilayer polymer assemblies formed with poly(acrylic acid) (PAA) have been found to be stable over a wide pH range (3-9) and in a range of organic solvents (ethanol, acetone and dimethylformamide).

The multilayer polymer assembly of the invention has also been found to be useful in the preparation of well-defined core-shell particles. The core-shell particle comprises a core and a shell material formed from the multilayer polymer assembly. In one preferred embodiment, the core-shell particle is a capsule that comprises a hollow core and a shell material comprising the multilayer polymer assembly of the invention.

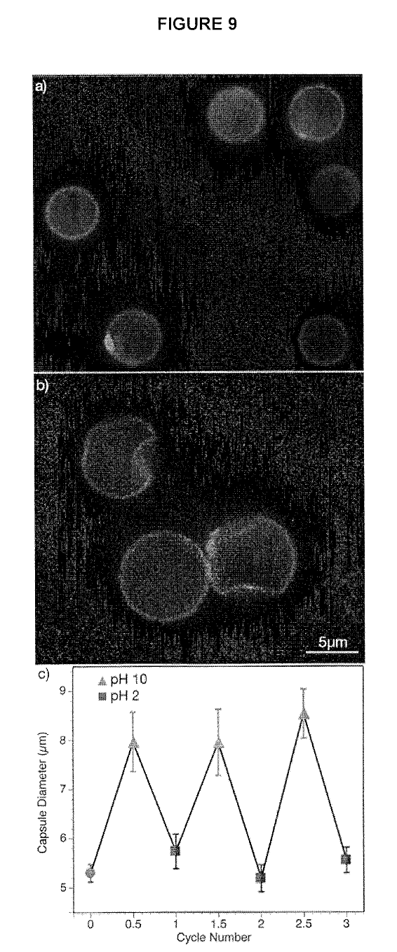

Core-shell particles prepared with poly(acrylic acid) as a multilayer shell material have been found to exhibit pH-responsive behaviour, For example, as shown in FIG. 9, incubation of PAA capsules in pH 10 and pH 2 solutions resulted in reversible swelling and shrinking of the capsules, respectively (FIG. 9a and FIG. 9b). The capsule diameter oscillated between about 5 and 8 μm in acidic and basic conditions, respectively (FIG. 9c). The capsules were observed to deform when swollen under basic conditions (FIG. 9b), but reverted to their original spherical shape when exposed to acidic conditions (FIG. 9a). Without being limited by theory, it is believed that the swelling is due to ionization of the carboxylic acid groups of the PAA at higher pH, while the deformation may be explained by the cross-linking between the layers, which causes the capsules to resist greater swelling, leading to buckling/deformation. Such pH-responsive behavior could be exploited to load and concentrate drugs inside the capsules. The core-shell particles of the invention may therefore be used in a variety of different applications, including for example, in drug delivery, as adsorbents and as micro-reactors.

The stable and responsive properties afforded in multilayer polymer assemblies of the invention together with ability to selectively post-functionalize the assemblies enables the polymer assemblies to serve as a versatile platform for designing advanced and responsive structures for use in a range of applications.

### EXAMPLES

The present invention is described with reference to the following examples. It is to be understood that the examples are illustrative of and not limiting to the invention described herein.

### Materials and Methods

### Materials

High-purity (Milli-Q) water with a resistivity greater than 18 MΩ cm was obtained from an in-line Millipore RiOs/Origin water purification system. Acrylic acid was purified by vacuum distillation and propargyl acrylate was purified by filtration through neutral alumina (70-230 mesh) immediately prior to use. Silica particles (diameter ˜5 μm) were obtained from Microparticles GmbH (Germany). Mesoporous silica (MS) particles, SGX200 (7.5 μm average diameter, 20 nm pores) and SGX1000 (5 □m average diameter, 100 nm pores), denoted herein as MS₂₀ and MS₁₀₀ respectively, were obtained from Tessek (Czech Republic). N-(3-dimethylaminopropyl)-N-ethylcarbodiimide (EDC) and Bis-[b-(4-azidosalicylamido)ethyl]disulfide (BASED) were purchased from Pierce. ω-Biotin α-NHS Ester PEG (M_{w} 3500 Da) and Methoxy PEG Succinimidyl Carboxy Methyl Ester (Mw 2300 Da) were purchased from JenKem Technologies Co., Ltd (USA). All other chemicals were purchased from Sigma-Aldrich, Merck or Fluka and used without further purification.

Microscope glass substrates (18 mm glass slides) were received from Knittel Glaser (Braunschweig, Germany). Glass substrates were cleaned with Piranha solution (70/30 v/v % sulfuric acid: hydrogen peroxide). The slides were then sonicated with 50:50 (isopropanol:water) for 15 min and finally heated to 60° C. for 20 min in RCA solution (5:1:1 water:ammonia:hydrogen peroxide). After each step the slides were washed thoroughly with Milli-Q water. Silicon wafers used for both ellipsometry and AFM were prepared using the above procedure without the Piranha treatment. Gold surfaces for IR measurement were cleaned by immersion in Piranha solution twice and then washed thoroughly with Milli-Q water. All substrates were immersed in poly(ethyleneimine) (˜25 KDa) with 0.5 M NaCl for 20 minutes before assembly of the click functionalized polymers. The substrates were then washed with Milli-Q water and dried with a stream of nitrogen. pH measurements were taken with a Mettler-Toledo MP220 pH meter, and the pH values were adjusted with 0.1 M HCl and 0.1 M NaOH.

MA104 monkey kidney epithelial cells (CRL-2378.1, ATCC, Rockville, Md.) were maintained in Dulbecco's Modified Eagle's Medium (DMEM) supplemented with 10% (v/v) fetal bovine serum (FBS), 50 units mL⁻¹ penicillin, 50 mg L⁻¹ streptomycin, 2 mM L-glutamine and 20 mM HEPES (Invitrogen, Carlsbad, Calif.). MA104 monkey kidney epithelial (ATCC CRL-2378.1) cells were shown to express α_{V}β₃ integrins by the following procedure: Cells were washed twice in stock flasks with phosphate buffered saline (PBS). 2 mL of 1 mM EDTA was the added to the flasks before incubating at 37° C. for no longer than 5 min. Approximately 8 mL of PBS was added to each stock flask and the contents then transferred to 50 mL centrifuge tubes. Cell numbers were adjusted to approximately 1×10⁶ cells mL⁻¹. 500 μL of cells were then transferred to smaller centrifuge tubes with FACS wash (1% FCS in PBS) subsequently added. Cells were then pelleted at 1400 rpm for 5 min. After supernatant removal, 50 μL of anti-α_{V}β₃ integrin monoclonal antibody (MAb) (LM609) (15 mg L⁻¹ in PBS) was then added to the cells before incubation on ice for 45 min. FACS wash was then added and cells were pelleted at 1400 rpm for 5 min. After supernatant removal, 50 μL of sheep anti-mouse IgG FITC-conjugated (Silenus TC09c, 1:100 FACS) was added and incubated for 45 min on ice. Cells were washed as previously mentioned and resuspended in 800 μL PBS. Samples were analyzed by flow cytometry performed on a BectonDickson FACSCalibur flow cytometer using an excitation wavelength of 488 nm. Cells incubated with both anti-α_{V}β₃ integrin MAb and FITC-conjugated secondary Ab demonstrated higher fluorescence intensity compared to cells alone and cells incubated with the secondary Ab.

### Peptide Functionalization:

Glass substrates and multilayer films were functionalized with GRGDSP-propargyl Gly and RAD-propargyl Gly peptides (AnaSpec. San Jose USA). A solution containing 200 μL of water, 50 μL sodium ascorbate (4.4 g L⁻¹), 50 μL copper(II) sulfate (0.45 g L⁻¹) and 2 μL of the appropriate peptide (1 g L⁻¹) was dropped onto the films and left to react for 15 min. These films were washed under a stream of water and dried with a stream of nitrogen. After analysis by ellipsometry, the film on silicon wafer was functionalized with the same conditions as those on glass substrates, although with complete submersion of the silicon wafer and three water washes of 1 min each.

### Cell Adhesion Studies:

Samples were prepared by submerging the substrates/films in ethanol for 2 min to prevent the growth of contaminants during incubation. Triplicate sets of samples were placed in 6 well plates and seeded with 2.5×10⁵ cells. Samples were then incubated for 72 h and samples from each set were removed approximately every 24 h for analysis.

Calcein AM (0.8 μL of 10 mg in 10 μL DMSO) was diluted into 750 μL of PBS. 2.5 μL of propidium iodide (PI) was diluted into 250 μL of PBS. A mixed solution for cell staining was produced by combining both solutions. Samples incubated with cells were removed from media. Excess media on the substrate/film was removed through capillary action by contacting the edge of the glass substrate with a paper wipe. The substrate was then placed on a larger slip for easy handling. Approximately 200 μL of stain was then dropped onto the upper surface and left for 3 min. Excess stain was removed with a paper wipe by capillary action. Excess stain and unattached cells were removed by dropping PBS solution across the surface at least 3 times. A glass coverslip was then placed over the top to prevent drying of the sample.

### Characterization Methods:

UV Spectrophotometry. UV-visible spectra were collected from multilayer films assembled on quartz substrates using a Varian 4000 double-beam UV-visible spectrophotometer. An air blank was used for all measurements

Ellipisometry: Measurements were performed on a UVISEL spectroscopic ellipsometer from Jobin Yvon. Spectroscopic data was acquired between 400 and 800 nm with a 2 nm increment, and thicknesses were extracted with the integrated software by fitting with a classical wavelength dispersion model.

Atomic Force Microscope: AFM images were acquired of air-dried multilayer films on silicon wafers with a MFP-3D Asylum Research instrument. Typical scans were conducted in AC mode with ultrasharp SiN gold coated cantilevers (NT-MDT) over 5 μm². Multilayer thicknesses were determined by scratching the multilayer with a razor blade exposing the substrate, and measuring the step height difference.

IR Spectroscopy: Measurements were taken using a Varian 7000 FT-IR Spectrometer with a variable angle reflectance attachment. The incident angle for the measurements was 70°. Films were deposited on reflecting substrates (glass slides coated with chromium (10 nm) and then gold (150 nm) using an Edwards Auto 306 thermal deposition chamber).

Gel Permeation Chromatography: SEC on a Shimadzu modular LC system comprising a DGU 12A solvent degasser, an LC-10AT pump, an SIL-10AD auto injector, an SIL-10A controller, an SPD-10AVP UV-Vis detector, an RID-10A refractive index detector, a Polymer Lab aquagel-OH 50×7.5 mm guard column and three 300×7.5 mm aquagel-OH columns (30, 40, 50) with a 8 μm particle size. The mobile phase/eluent used is made up of water (distilled H₂O+0.02% NaN₃). The system was calibrated with sodium polystyrene sulphonate standards (4,600˜400,000 g mol⁻¹).

X-ray Photoelectron Spectroscopy (XPS): XPS enabled characterization of the surface composition of the films. A KRATOS Analytical AXIS-HIS spectroscopic instrument with a monochromated Al Kₐ radiation source operated below 5×10⁻³ mbar with an analysis area of approximately 0.8 mm² was used to measure three locations per sample.

DIC and Fluorescence Microscopy. An inverted Olympus IX71 microscope equipped with a DIC slider (U-DICT, Olympus) with a 40× objective lens (Olympus UPLFL20/0.5 N.A., W.D. 1.6) was used to view the core-shell and hollow particles. A CCD camera (Cool SNAP fx, Photometrics, Tucson, Ariz.) was mounted on the left hand port of the microscope. Transmission and DIC images were illuminated with a tungsten lamp, and the fluorescence images were illuminated with a Hg arc lap, using a UF1032 filter cube.

Flow Cytometry. Flow cytometry was performed on a Becton Dickinson FACS Calibur flow cytometer. 5 μL of the particle suspension was diluted in 250 μL of 0.1 M HCl solution. Measurements were acquired by triggering on the forward scatter detection (EO detector) with a threshold of 400. Rhodamine fluorescence was monitored on the FL2 (570-610 nm) parameter with a PMT voltage of 600 V. Flow cytometry data analysis was performed with Summit v. 3.1 software (Cytomation Inc., Colorado, USA). The mean fluorescence intensity was obtained from the fluorescence intensity histograms.

Transmission Electron Microscopy: Air-dried hollow capsules were characterized with a Philips CM120 BioTWIN TEM operated at 120 kV.

Cell Growth: An Olympus BX60 microscope equipped with a 10× objective lens was employed to observe cell growth. Mounted on the microscope was a CCD camera (Q imaging Regita 1300R) used to capture sets consisting of brightfield, red-channel (PI) and green-channel (Calcein) fluorescent images. With images taken in black and white, at least 7 sets per surface type were obtained for a representation of the extent of cell adhesion, growth and morphology. Using Photoshop®, images showing fluorescent live and dead cells were converted to RGB format, false colored, and combined into a single representation. Numbers of adhered cells (between 4-200 cells for all surfaces) were obtained from these images by manual counting and were averaged over the image area and standard deviations calculated. Each image corresponded to an area of 0.72 mm².

Confocal Laser Scanning Microscopy (CLSM): CLSM images were taken using a Leica TCS-SP2 confocal laser scanning microscope using a Picoquant 405-nm pulsed diode laser as the excitation source. Fluorescent click NPS were imaged in x-y mode with a 63× planapochromatic oil immersion objective using a PMT gain of 550 V, a digital zoom of 2×, a line frequency of 400 Hz, and 4× line averaging in 12-bit acquisition mode.

### Example 1

### Preparation of Poly(Acrylic Acid) Multilayer Films

### Synthesis of 3-Chloropropyl Acrylate

3-chloropropan-1-ol (8.27 mL), triethylamine (17.57 mL) and hydroquinone (0.1 g) were added to dichloromethane (50 mL) and stirred for 10 min. Acryloyl chloride (9.53 mL) was then added drop-wise under argon at 0° C. The reaction was left to stir at 0° C. for 60 min and then at room temperature overnight. The reaction was purified by washing with 100 mL water (twice), 0.5 M HCl, 100 mL water (twice) and then dried with magnesium sulfate (MgSO₄). The crude product was purified by rotary evaporation and then distilled. 2.23 mL (33.5% conversion) of clear liquid was produced. ¹H NMR (D₂O): 2.10 (m, CH₂) 3.59 (m, CH₂—Cl), 4.27 (m, O—CH₂), 5.79 (d, ═CH₂), 6.07 (m, ═CH) 6.35 (d, ═CH₂) ppm.

### Synthesis of Dodecyl 1-Phenylethyl Carbonotrithioate

Dodecane thiol (4.8 g), carbon disulphide (3.6 g), triethylamine (4.8 g), and dichloromethane (15 mL) were added to a round-bottom flask and stirred overnight. 1-bromoethyl benzene (3.6 g) in a further 10 mL dichloromethane was added and then the reaction was stirred again overnight. The purity of the reaction was confirmed using TLC (diethyl ether:hexane (3:1)). The product was washed several times with water, brine and then dried over magnesium sulfate. The product was rotary evaporated to produce 6.21 g (83.8% conversion) of yellow solid material. ¹H NMR (CDCl₃): 0.85 (t, CH₂CH₃), 1.23 (s, CH₂CH₂), 1.36 (m, CH₂CH₃), 1.65 (m, CH₂CH₂S), 1.72 (d, CH₃CH), 3.32 (m, CH₂S), 5.30 (CH₃CH), 7.29 (m, benzylic CH).

### Synthesis of Azide and Alkyne Click-Functionalized Poly(Acrylic Acid)

Poly(acrylic acid) with azide functionality (PAA-Az) was synthesized with the following procedure: initial reactants were mixed at a 270:30:1 molar ratio of acrylic acid (0.932 g), 3-chloropropyl acrylate (0.236 g), and RAFT agent (dodecyl 1-phenylethyl carbonotrithioate (0.018 g). 10 wt % Azobisisobutyronitrile (0.7 mg) relative to the RAFT agent was also added. The solution was purged by bubbling with nitrogen for 45 min and then polymerized at 60° C. in a constant temperature oil bath (2 h). The product was dialyzed for 24 h to remove excess monomer. The polymer was then stirred overnight with sodium azide at 60° C. (0.29 g). The final product was then dialyzed again for 24 h and freeze dried. ¹H NMR (D₂O): 1.24-1.84 CH₂ (polymer), 1.88-2.50 CH+pendant CH₂CH₂CH₂ (polymer), 3.25-3.61 pendant CH₂N₃ (polymer), 3.84-4.18 pendant OCH₂ (polymer). The yellowish polymer obtained had a molecular weight of 86000 (M_{w}) with a polydispersity of 2.21.

Poly(acrylic acid) with alkyne functionality (PAA-Alk) was synthesized using the same procedure as above. However, the molar ratio used was 300.1 acrylic acid to RAFT agent. The polymer was heated at 60° C. in a constant temperature oil bath for 3 h. The polymer was stirred overnight with propargyl amine (0.10 molar equivalents) in the presence of 1-[3′-(dimethylamino)propyl]-3-ethylcarboimide methoiodide (0.15 molar equivalents). The product was dialyzed for 7 days and then freeze dried. ¹H NMR (D₂O): 0.96-1.78 CH₂ (polymer), 1.86-2.52 CH+pendant alkyne CH (polymer), 3.62-3.87 pendant NHCH₂ (polymer). The yellowish polymer obtained had a molecular weight of 61000 (M_{w}) with a polydispersity of 1.52.

### Synthesis of Poly(Acrylic Acid) Multilayer Films

Poly(acrylic acid) with either azide (PAA-Az) or alkyne functionality (PAA-Alk) was synthesized using living radical polymerization in accordance with the procedure described above. NMR analysis showed that PAA-Az (Mw 86,000) and PAA-Alk (Mw 61,000) contained at least ˜10% of the respective functional groups for cross-linking. Infrared spectroscopy showed the characteristic azide peak at 2100 cm⁻¹ for PAA-Az and a fingerprint weak alkyne peak at 2120 cm⁻¹ for PAA-Alk, confirming functionalization of the polymers.

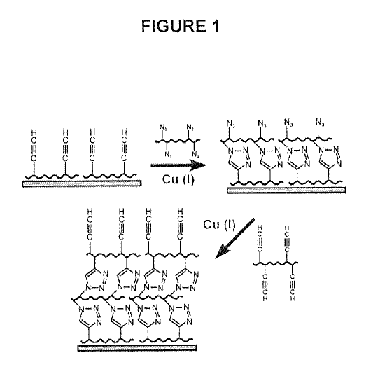

The azide and alkyne functionalised PAA polymers were assembled in a layer-by-layer approach with Cu(I) as a catalyst in accordance with the scheme shown in FIG. 1.

LbL assembly was performed by sequentially exposing a quartz, silicon or gold substrate to PAA-Az and PAA-Alk solutions containing copper sulfate and sodium ascorbate for 20 min, with water rinsing after deposition of each layer. Dipping solutions were prepared from the following stock solutions: (a) PAA-Az (0.83 mg mL−1), (b) PAA-Alk (0.83 mg mL−1), (c) MilliQ water (pH 3.5), (d) copper sulfate (0.36 mg mL−1), and (e) sodium ascorbate (0.88 mg mL−1). The pH of each solution was adjusted to pH 3.5 using 0.1 M HCl. Polymer dipping solutions were made up in a constant volume ratio of 3 (a or b)-1(d):1(e). The aqueous wash solutions were made up in a similar ratio, however, using solution (c) in place of (a) or (b). To prevent oxidation of the copper, new copper stock solutions were prepared after deposition of each PAA-Az/PAA-Alk bilayer.

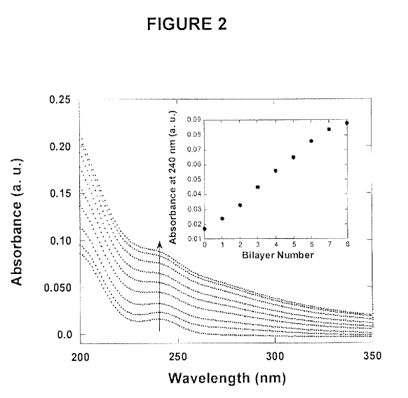

LbL assembly of the PAA-Az/PAA-Alk multilayers was first monitored by UV-vis spectroscopy. As shown in FIG. 2, linear growth of the film was observed by monitoring the peak at 240 nm, which corresponds to the complex formation between copper and the PAA. A control system of PAA without click groups (PAA/PAA), used for comparison, showed a plateau in absorbance after only two bilayers, indicating that the click groups are essential for the deposition of consecutive PAA layers and the formation of PAA multilayers.

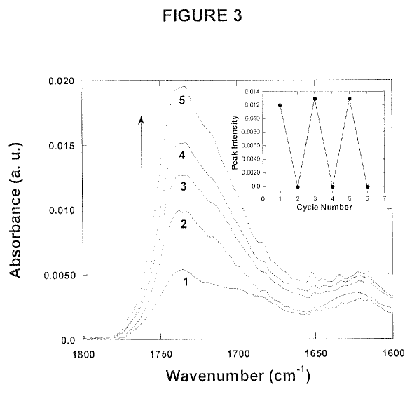

The prepared multilayer films were further characterized by reflection-absorption Fourier transform infrared spectroscopy (RAS-FTIR). The carboxylic acid peak at 1700 cm⁻¹ from the PAA multilayers was used to monitor the film build-up on a gold surface (FIG. 3). The arrow shown in FIG. 3 indicates increasing bilayer number (bottom to top: bilayers 1, 2, 3, 4 and 5). The film absorbance was observed to increase regularly with bilayer number, in accordance with the UV-vis data (FIG. 2).

The 5-bilayer film assembly was prepared in accordance with the above procedure was demonstrated to be stable to pH cycling (FIG. 3 inset). The peak at 1700 cm⁻¹ could be reversibly switched between protonated and deprotonated forms by immersion of the film in alternating solutions of pH 3.5 and 9.5 (the peak height is given as zero as it disappears into the bulk spectra at basic pH and is too low to assign). The peak height at pH 3.5 remained essentially constant, indicating negligible polymer desorption during the cycling experiments. This result provides further evidence that the film is constructed using covalent interactions, as PAA films assembled using hydrogen bonding interactions would disassemble under these basic conditions. The film stability is attributed to the triazole cross-links between the layers of polymer.

### Example 2

### Preparation of 4- and 8-Bilayer Poly(Acrylic Acid) Multilayer Films

PAA-Az/PAA-Alk multilayer film assemblies of 4- and 8-bilayers were prepared on poly(ethyleneimine) (PEI)-coated silicon substrates in accordance with the method described in Example 1. The initial PAA-Az layer was adsorbed onto the substrate using electrostatic interactions. The obtained multilayer films were then air-dried.

The thickness of air-dried PAA-Az/PAA-Alk multilayer films (4- and 8-bilayers) was determined by spectroscopic ellipsometry. Film thicknesses of 25±6 nm and 38±4 nm were calculated for the 4- and 8-bilayer systems, respectively. Taking into account the thickness of the PEI-PAA-Az prelayers (4 nm), we obtain PAA-Az/PAA-Alk average bilayer thicknesses of approximately 4.6 nm, or a PAA layer thickness of about 2.3 nm.

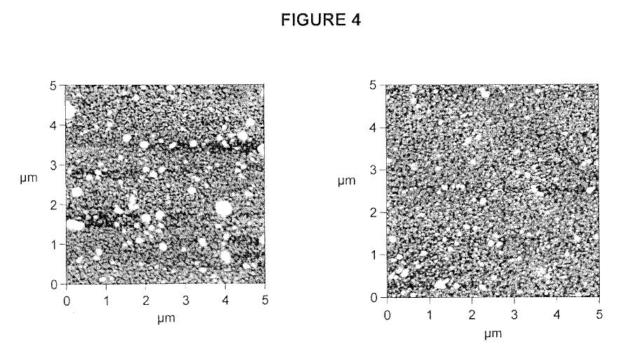

The morphology of the air-dried click PAA multilayer films was examined by atomic force microscopy (AFM). The resulting images are shown in FIG. 4. Surface roughness over 5×5 μm² was approximately 4 and 6 nm for the 4- and 8-bilayer films, respectively.

Thickness of the multilayer films was also determined by scratching the surface and measuring the step increment with the AFM. Thickness values (for films comprising the PEI/PAA-Az prelayers) consistent with those measured by ellipsometry were obtained: 22±4 nm and 43±7 nm for the 4- and 8-bilayer films, respectively.

### Example 3

### Functionalised Poly(Acrylic Acid) Multilayer Films

Poly(acrylic acid) containing ˜10% of either the alkyne (PAA-Alk) or azide (PAA-Az) functional groups was synthesized using living radical polymerizationin accordance with the procedure described in Example 1. To monitor multilayer growth via fluorescence intensity changes, the PAA-Alk was also modified with an azide-functionalized rhodamine dye (Rh-Az).

To prepare PAA-Alk polymer modified with the Rh-Az functional compound, PAA-Alk (40 mg) was added to a round bottom flask with copper sulfate (5.6 mg) and sodium ascorbate (12.8 mg) in 20 mL of water. A stock solution of azide-functionalized rhodamine dye (tetramethylrhodamine 5-carbonyl azide) was made up of 0.1 mg of material dissolved in 1 mL dimethyl sulfoxide (DMSO). An aliquot of 0.1 mL of the dye solution was then added to the round bottom flask and stirred for 16 h. The pink solution obtained was dialyzed for several days and then freeze-dried.

LbL assembly of the polymer materials on colloids was performed by sequentially exposing 5 μm poly(ethyleneimine) (PEI)-coated silica particles to PAA-Alk and PAA-Az solutions (0.83 mg mL−1) containing copper sulfate (1.8 mg mL−1) and sodium ascorbate (4.4 mg mL−1) at pH 3.5. The particles were incubated for 15 min in each PAA solution to deposit the polymer. The particles were then centrifuged and washed three times with water.

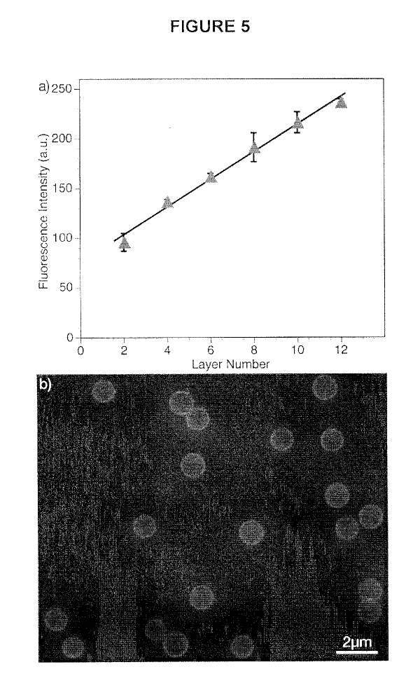

The growth of the PAA-Az/PAA-Alk click multilayers was monitored using flow cytometry. This approach is based on recording the fluorescence intensity of tens of thousands of individual particles after deposition of fluorescently labeled materials, comprising polymer layers. As seen in FIG. 5 the increase in fluorescence intensity of the dye (Rh-Az)-functionalized PAA-Alk, and thus the mass of each PAA-Alk layer, was shown to be linear to at least a total of 12 (PAA-Az/PAA-Alk) layers. This suggests linear growth of the click multilayers. The relatively large fluorescence intensity observed for the first PAA-Alk layer (layer 2), compared with subsequent layers, is attributed to electrostatic association of the first PAA layer with the PEI primer layer on the silica particle. Fluorescence microscopy confirmed that the polymer multilayer coating on the particles was uniform.

### Example 4

### Core-Shell Particle with Poly(Acrylic Acid) Multilayer Shell

Core-shell particles comprising a multilayer polymer film as the shell material was prepared by LbL assembly on a colloid particle. The multilayer polymer assembly was prepared according to the following procedure: Approximately 200 μL of 5 wt % silica particles and 1.5 mL of water were added to a 2 mL centrifuge tube. The particles were first washed 3 times with water. The tube was agitated with a vortex mixer and then centrifuged at 1000 g for 1 min. This resulted in a pellet forming at the bottom of the tube. Approximately 1.5 mL of the supernatant was removed and replaced with water. This was repeated twice prior to polyelectrolyte coating. After the last wash approximately 1.5 mL of poly(ethyleneimine) (PEI) solution (1 mg mL⁻¹, 0.5 M NaCl) was added to establish a PEI layer on the particles. This dispersion was allowed to incubate for 15 min, followed by 3 washing steps with Milli-Q water.

The following stock solutions were made: (a) PAA-Az (0.83 mg mL⁻¹), (b) PAA-Alk (0.83 mg mL⁻¹), (c) copper sulfate (1.8 mg mL⁻¹) and (d) sodium ascorbate (4.4 mg mL⁻¹). The pH of each solution was adjusted to 3.5 using 0.1 M HCl. The final PAA solutions for adsorption were made up in a constant volume ratio of 3 (a or b):1(c):1(d). To prevent oxidation of the copper, new copper stock solutions were prepared after deposition of each PAA-Az/PAA-Alk bilayer.

After pre-coating with PEI, 1.5 mL of PAA-Az solution (containing copper and ascorbate) were added and allowed to incubate for 15 min. After adsorption, the particles were washed 3 times with water (centrifugation speed of 100 g for 2 min to prevent particle aggregation). This was followed by adsorption of PAA-Alk, followed by the same washing steps with water. The process was repeated until the desired number of layers was deposited.

The (PAA-Az/PAA-Alk)₄-coated silica particles were modified with azide-functionalized rhodamine dye (Rh-Az) according to the following procedure: 0.5 μL of 0.1 mg mL⁻¹ of Rh-Az was diluted in 1.5 mL of Milli-Q water. 0.6 mL of this solution was mixed with 0.2 mL of copper sulfate (1.8 mg mL⁻¹) and 0.2 mL (4.4 mg mL⁻¹) of sodium ascorbate solutions. This mixture is then added to the (PAA-Az/PAA-Alk)₄-coated silica particles and allowed to incubate for 30 min. Then the particles were washed with pH 3.5 water three times and 50/50 v/v DMSO/water 5 times to remove any unbound dye. The particle suspension was then dialyzed exhaustively against DMSO/water solution and washed another 10 times with DMSO/water solution. As a control, rhodamine dye that has not been click functionalized was used in place of Rh-Az. In the adsorption solution, pH 3.5-water was used instead of the copper sulfate and sodium ascorbate solutions. All other procedures were the same as above.

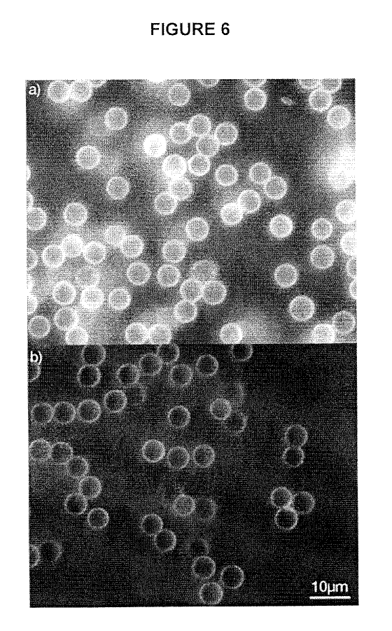

Both the Rh-Az and non-functionalized Rh (Rh) were used to demonstrate the specificity of coupling of Rh-Az to the free Alk click groups in the multilayers. Rh showed some level of non-specific binding to the (PAA-Az/PAA-Alk)-coated particles, however after the particles were subjected to multiple washing steps in both 50/50 v/v dimethyl sulfoxide (DMSO)/water solution (to remove unbound Rh) and acidic water (to remove copper) and finally extensive dialysis, the particles exposed to Rh-Az showed significantly higher fluorescence (a factor of 2.5) than those exposed to unmodified Rh (FIG. 6). This indicates that the click-functionalized Rh-Az dye was specifically clicked onto the (PAA-Az/PAA-Alk) multilayers assembled on the particles.

### Example 5

### Hollow Core-Shell Particle with Poly(Acrylic Acid) Multilayer Shell

The core-shell particles prepared in Example 4 were treated with ammonium fluoride-buffered hydrofluoric acid (HF) at pH 5 remove the silica particle core. The silica core was dissolved by mixing 1 μL of the polymer-coated particle suspension with 1 μL of ammonium fluoride (8 M) buffered HF (2 M) at pH 5 and the capsules were visualized in situ. Dissolution of the silica core occurred after less than 1 min. The particles were imaged on an Olympus IX71 fluorescence microscope.

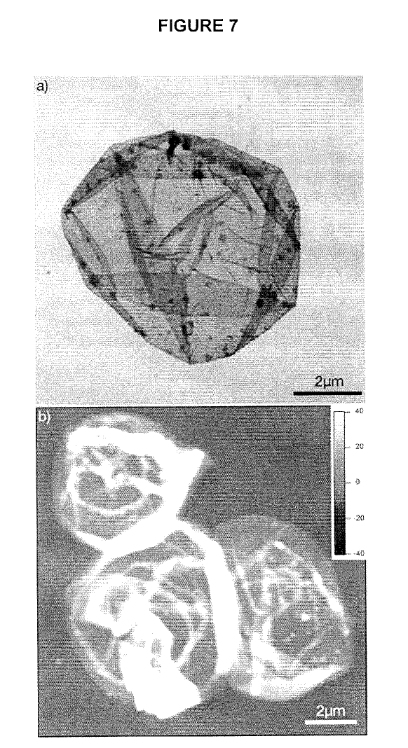

The resulting hollow spherical capsules were characterized with transmission electron microscopy (TEM) and atomic force microscopy (AFM). After drying, the capsules were observed to collapse and folds were visible from TEM and AFM images (FIG. 7).

AFM was used to determine the thickness of the capsule walls by taking a cross-sectional profile of the capsules where they folded only once and then halving the thickness. The wall thickness of the 12-layer (PAA-Az/PAA-Alk)₆ capsules (comprising a PEI primer layer from the substrate) was calculated to be 4.8 nm. This corresponds to less than 0.4 nm per PAA layer.

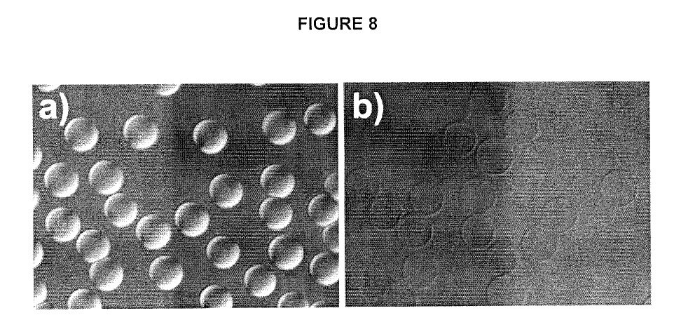

The formation of capsules was also verified by using differential interference contrast (DIC) microscopy. The results are shown in FIG. 8. This technique distinguishes materials based on changes in refractive index instead of light absorption and, as such, capsules appear distinctly different to core-shell particles. This confirmed that the solid silica core was dissolved and that single component PAA capsules were prepared.

The effect of pH on the PAA capsules was investigated. pH-induced swelling and shrinkage of the capsules was performed by alternately adding 1 μL of HCl at pH 2 and 1 μL of 10 mM sodium carbonate (NaHCO₃/Na₂CO₃) buffer solution at pH 10 directly to the click capsule solution on the microscope slide. The shrinkage or swelling of the capsules occurred within less than 1 min of adding the acidic or basic solution. The size of the capsules quoted is the average of about 10 capsules.

The capsules were alternately incubated in pH 10 and pH 2 solutions, resulting in reversible swelling and shrinking of the capsules, respectively (FIG. 9a and FIG. 9b). The capsule diameter oscillated between about 5 and 8 μm in acidic and basic conditions, respectively (FIG. 9c). The capsules were observed to deform when swollen under basic conditions (FIG. 9b), but reverted to their original spherical shape when exposed to acidic conditions (FIG. 9a). The swelling is attributed to ionization of the carboxylic acid groups at higher pH, while the deformation may be explained by the cross-linking between the layers, which causes the capsules to resist greater swelling, leading to buckling/deformation. Size measurements were performed only on the capsules that had not deformed.

### Example 6

### Poly(Acrylic Acid) Based Nanoporous Spheres

Poly(acrylic acid) containing ˜10% of either the alkyne (PAA-Alk) or azide (PAA-Az) functional groups was synthesized using living radical polymerisation in accordance with the procedure described in Example 1.

Assembly of nanoporous silica spheres was performed by sequentially exposing ˜7.5 μm amine modified silica particles to PAA-Alk and PAA-Az solutions (0.83 mg mL-1) containing copper sulfate (1.8 mg mL−1) and sodium ascorbate (4.4 mg mL−1) at pH 3.5. The particles were incubated overnight in each PAA solution to deposit the polymer. The particles were then centrifuged and washed three times with water.]

Alternatively PAA-Alk was infiltrated into ˜7.5 μm amine modified silica particles overnight and was then subsequently cross-linked with Bis-[b-(4-Azidosalicylamido)ethyl]disulfide (BASED) dissolved in ethanol (0.83 mg mL−1) containing copper sulfate (1.8 mg mL−1) and sodium ascorbate (4.4 mg mL−1).

### Example 7

### Poly(Acrylic Acid) Based Nanoporous Spheres (PAA-NPS)

PAA_{Az} and PAA_{Alk} with <15% alkyne or azide functionality were prepared in accordance with the procedure of Example 1.

The azide and alkyne linkers shown below were synthesised in accordance with the procedures described in Journal of Organic Chemistry, 2003, 69, 609 and Tetrahedron Letters, 1998, 39, 3319.

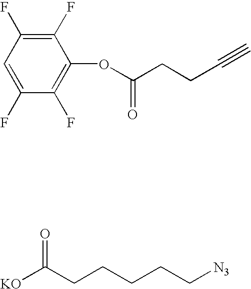

### (a) Mesoporous Silica (MS) Sphere Modification

For PAA-based NPS, MS spheres were amine-functionalized by incubating 100 mg of MS spheres with 10 mL of ethanol, 2 mL of 3-aminopropyltrimethoxysilane (APTS) and 0.5 mL of 28% ammonia solution overnight (at least 8 hr) in room temperature to invert the surface charge of the spheres and thereby facilitate PAA loading. After this, the amine-functionalized MS spheres underwent centrifugation/washing cycles in ethanol (twice) and in water (three times).

(b) Polymer Loading into MS Spheres

For PAA-based NPS, 1.5 mL of PAA_{Alk} polymer solution were gently shaken with 1.5 mg of MS template for at least 8 hours to allow electrostatic adsorption, followed by three washing/centrifugation cycles in DI water to harvest the modified MS spheres. PAA-polymer loading was performed at room temperature.

### (c) Cross-Linking Via Click Chemistry

1.5 mL of PAA_{Az} was added to an equivalent of 1.5 mg of the modified MS spheres prepared above to crosslink the PAA_{Alk} multilayers. The incubation was allowed to proceed for at least 8 h. This was followed by the addition of 0.5 mL each of copper sulphate and sodium ascorbate.

The click reaction was allowed to proceed for >2 h, followed by extensive centrifugation/washing cycles with pH 2HCl, DI water, ethanol and/or DMF. The final bulk solutions, at the end of centrifugation/washing cycles, are either deionized water or phosphate buffer and have near neutral pH.

### (d) MS Template Dissolution

MS templates were dissolved by exposure to ammonium fluoride (NH₄F)-buffered hydrofluoric acid (HF). Briefly, 10 μL of modified MS spheres (˜0.2 mg of starting MS template) were shaken with 10 μL of 2 M HF/8 M NH₄F for 120 s. The resulting NPS were then collected after at least 3 centrifugation/water washing cycles. PAA-based NPS were centrifuged at 500 g for 5 min, while other click NPS were centrifuged at 30 g for 10 min.

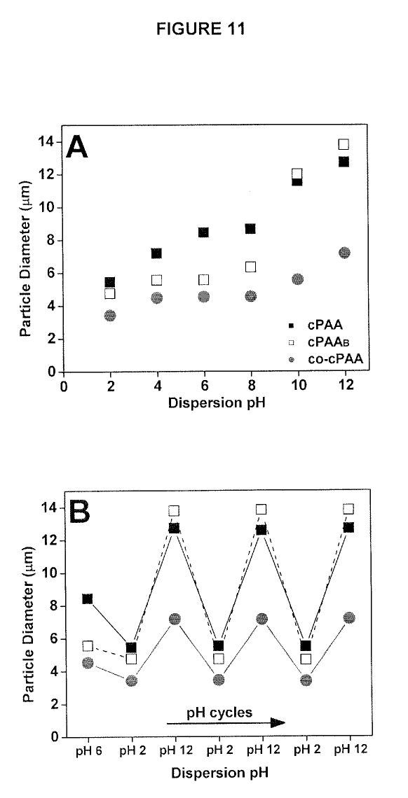

The resulting PAA-NPS were dispersed in pH 2 and 12 bulk solutions, respectively and the pH-responsive size variation of PAA-NPS observed. FIG. 11A shows the pH-dependent size variation of PAA-NPS across the range of pH investigated. In pH 2, PAA-NPS shrunk from a starting diameter of ˜7.5 μm to 5.5 μm. The diameter of the PAA-NPS was restored upon repeated washings in intermediate pH solutions (in the range of pH 4-8), followed by swelling at pH 10 that eventually reached a maximum diameter of ˜13 μm at pH 12 (˜250% diameter change from pH 2). FIG. 11B highlights the dynamic nature of PAA-NPS by confirming that the pH-responsive size variation is reversible upon repeated washing in pH 2 and 12 solutions. Repeated exposure to extreme pH environment did not compromise the structural and colloidal stability of PAA-NPS. Variations in the pH of the bulk solution led to conformational rearrangements of the underlying PAA chains at different pH, which resulted in changes in the PAA-NPS diameter.

TEM analysis of PAA-NPS dried from extreme pH conditions (pH 2 and 12) revealed that the diameter of the pH 12 particle decreased more dramatically under high vacuum, despite maintaining a larger diameter. The result highlighted the role of water content in the swelling of PAA-NPS in high pH. High magnification TEM analysis revealed that pH 12 PAA-NPS have a very “sparse” surface morphology when compared to pH 2 particles, which may be due to stretched underlying PAA-chains contributing to its larger diameter. The observations suggest that conformational rearrangements and water retention have a role in influencing the diameter of PAA-NPS.

### Example 8

### BASED Crosslinked PAA-NPS (PAA_{B}-NPS)

In this experiment bis-[b-(4-Azidosalicylamido)ethyl]disulfide (BASED), was used to crosslink PAA-NPS. PAA-NPS were prepared as described in Example 7 except that in part (c) 1.5 mL of bis-[b-(4-azidosalicylamido)ethyl]disulfide BASED was added to an equivalent of 1.5 mg MS spheres in place of PAA_{Az} to crosslink the PAA layers. The incubation was allowed to proceed for at least 8 hr. This was followed by the addition of 0.5 mL each of copper sulphate and sodium ascorbate. DIC images confirmed that BASED provided sufficient cross-linking to yield stable cross-linked PAA-NPS (PAA_{B}-NPS) upon template removal.

Upon dispersion in pH 2 and 12 bulk solutions, DIC microscopy analysis reveals that PAA_{B}-NPS undergoes ˜300% diameter variation from pH 2 to pH 12. FIG. 11A depicts the particle diameter variation across the investigated pH range, and showed that PAA_{B}-NPS underwent an abrupt swelling between pH 8 and pH 10. FIG. 11B revealed that PAA_{B}-NPS retains the reversible shrinking/swelling properties when consecutively washed in pH 2 and pH 12 bulk solutions (5-14 μm for PAA_{B}-NPS, 5.5-13 μm for PAA-NPS). Importantly, PAA_{B}-NPS were observed to be stable despite repeated exposure to extreme pH conditions.

### Example 9

### Preparation of PAA-NPS by Co-Adsorption of PAA_{Alk} and PAA_{Az} Layers (co-PAA-NPS)

In this experiment PAA_{Alk} and PAA_{Az} layers were simultaneously introduced for co-adsorption into MS₂₀ and MS₁₀₀ spheres (7.5 and 4.5 μm average diameter respectively).

The PAA-NPS were prepared according to the procedure described in Example 7 except that 0.5 mL each of copper sulphate and sodium ascorbate were added to a solution comprising of PAA_{Alk}, PAA_{Az} and MS spheres prior to incubation of the solution. The polymer solutions contained equal parts in volume (0.75 mL each) of both adsorbing species PAA_{Alk} and PAA_{Az}. Co-adsorbed PAA-NPS (co-PAA-NPS) were formed upon addition of catalytic mixture (copper sulfate and sodium ascorbate) and MS template removal. DIC analysis revealed that co-PAA-NPS were successfully fabricated when MS₁₀₀ spheres were used as the adsorption scaffold.

The co-PAA-NPS were washed cyclically in alternating pH 2 and pH 12 solutions to confirm the reversibility of NPS diameter variation as seen in FIG. 11B. The particles were observed to oscillate between approximately 3.5-7 μm.

### Example 10

### Poly(Ethylene Glycol Acrylate) (PEG Acrylate) Multilayer Films

### Synthesis of Halogen-Terminated PEG Acrylate and Methoxy-Terminated PEG Acrylate

2-[2-2-chloroethoxy)-ethoxy]ethanol (10 g), triethylamine (10.31 mL) and hydroquinone (0.12 g) were added to dichloromethane (75 mL) and stirred for 10 min. Acryloyl chloride (5.23 mL) in a further 25 mL dichloromethane was then added drop-wise under argon at 0° C. The reaction was left to stir at 0° C. for 60 min and then at room temperature overnight. The reaction was purified by washing with 100 mL water (twice), 0.5 M HCl, 100 mL water (twice), 0.5 M NaOH, brine and then dried with magnesium sulfate (MgSO₄). The crude product was purified by rotary evaporation producing 9.3 g of pale yellow liquid. ¹H NMR (D₂O): 3.57-3.75 OCH₂CH₂, 4.28 COOCH₂, 5.80, 6.11 and 6.39 vinyl CH and CH₂.

A methoxy terminated compound was synthesized as above however using triethylene glycol.

### Synthesis of Azide and Alkyne Click-Functionalised PEG Acrylate

Polymerization of PEG acrylate was conducted using the same method as previously reported for the synthesis of click-functionalized PAA in J. Am. Chem. Soc., 2006, 128, 9318, however, with triethylene glycol incorporated as the pendant chains of the structure.

(PEG-Az): Poly(ethylene glycol)₃ acrylate with azide functionality (PEG-Az) was synthesized with the following procedure: initial reactants were mixed at approximately a 350:50:1 molar ratio of methoxy terminated poly(ethylene glycol)₃ acrylate (0.854 g), chorine terminated poly(ethylene glycol)₃ acrylate (0.158 g), and RAFT agent (dodecyl 1-phenylethyl carbonotrithioate (0.0038 g)) as used in Macromolecules 2006, 39, 5293, however, with dodecyl substituting the butyl group. 10 wt % azobisisobutyronitrile (0.2 mg) relative to the RAFT agent was also added and 3 mL dioxane. The solution was degassed using three freeze-evacuate-thaw cycles on a vacuum line and then polymerized at 60° C. in a constant temperature oil bath (23 h). The product was dialyzed for 48 h to remove excess monomer. The polymer was then stirred for several days with sodium azide at 60° C. (1 g). The final product was then dialyzed again for 48 h and freeze dried. Following this procedure, PEG-Az (M_{w} 8 000) was prepared.

PEG-Alk: Poly(ethylene glycol)₃ acrylate with alkyne functionality (PEG-Alk) was synthesized using a similar procedure as that described above with a molar ratio of approximately 350:50:1 methoxy terminated poly(ethylene glycol)₃ acrylate (1.712 g), acrylic acid (1.01 g) and the above RAFT agent (7.5 mg). 10 wt % azobisisobutyronitrile (0.2 mg) relative to the RAFT agent was also added and 3 mL dioxane. The solution was degassed using three freeze-evacuate-thaw cycles on a vacuum line and then polymerized at 60° C. in a constant temperature oil bath (36 h). The polymer was stirred overnight with propargyl amine (0.010 g) in the presence of 1-[3′-(dimethylamino)propyl]-3-ethylcarboimide (0.150 g). The product was dialyzed for 7 days and then freeze dried. Following this procedure PEG-Alk (M_{w} 8 000) was prepared.

Nuclear magnetic resonance (NMR) spectroscopy showed that PEG-Az contained approximately 15% azide groups and PEG-Alk 40% alkyne groups.

### Preparation of PEG Acrylate Multilayer Films

LbL assembly onto silicon wafers was promoted by the adsorption of primer layers (PEI/PAA-Az) to facilitate ‘clicking’ of subsequent PEG acrylate layers. As an alternative means to attach click layers to a substrate, the substrate can be modified by having the halogen groups presented by 3-chloropropyl triethoxysilane-modified silica exchanged for azide groups, allowing an alkyne-functionalized polymer to be attached. In order to deposit the PEG acrylate layers onto modified silicon substrates, surfaces were dipped sequentially in a solution containing PEG-Alk or PEG-Az, with both containing the copper(I) catalyst. Substrates were washed in water and dried with nitrogen between deposition of each layer.

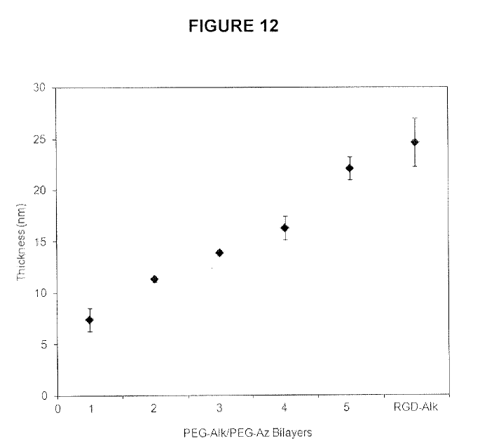

Growth of the PEG acrylate multilayer structure was observed using spectroscopic ellipsometry. (FIG. 12) shows a linear buildup of five PEG bilayers (PEG-Alk/PEG-Az) onto silicon wafers. A thickness of 22±1 nm is obtained for the (PEG-Alk/PEG-Az)₅ multilayer. With the exclusion of the primer layers, an average thickness increase of approximately 3.9 nm per PEG bilayer is observed.

### Example 11

### Peptide Functionalised PEG Acrylate Multilayer Film

In this example, free azide groups present on the surface of a PEG-Alk/PEG-Az multilayer film prepared in accordance with Example 10 is used to attach a cell adhesion promoting peptide sequence arginine-glycine-aspartate (RGD) to the film. Functionality was imparted to the click PEG films using N/C-terminal GRGDSP-propargyl Gly and RAD-propargyl Gly molecules. The former sequence was chosen for its high binding affinity towards the α_{V}β₃ integrin and the latter as a negative control by altering the peptide sequence through the replacement of glycine by alanine. Successful attachment of these peptides was also by confirmed by ellipsometry.

The (PEG-Alk/PEG-Az)₅ multilayer films functionalized with RGD were examined using atomic force microscopy (AFM). Surface roughness (RMS) values of the PEG films were observed to change from 3.4 to 2.2 nm upon the attachment of the RGD peptide, indicating a modification of the surface. Further qualitative evidence for the successful attachment of RGD to the films was provided by (PEG-Alk/PEG-Az)₅ films contacted with a solution containing rhodamine-labelled RGD-propargyl Gly, in the presence and absence of Cu(I) catalyst. Films contacted with the fluorescent solution with Cu(I) catalyst showed fluorescence, whereas in the absence of Cu(I) no fluorescence was observed from the films.

### Example 12

### Cell Adhesion and Cell Growth on PEG Acrylate Multilayer Films

To evaluate the activity of the immobilized RGD peptide on (PEG-Alk/PEG-Az)₅ films, monkey kidney epithelial cells shown to express α_{V}β₃ integrins were incubated in the presence of untreated glass (control) and (PEG-Alk/PEG-Az)₅ multilayers that were either functionalized with RGD or RAD or unfunctionalized. RAD is a tripeptide arginine-alanine-aspartate, which generally does not promote cell adhesion. In addition, the potential of the PEG films to provide a low-biofouling surface was assessed by comparison of cell adhesion on untreated glass and PEG multilayers.

The different surface types (untreated glass, PEG, RGD, RAD) were incubated in 6 well plates with 2.5×10⁵ cells in triplicate. Samples were removed at 24 h intervals, stained to distinguish live cells (calcein AM) from dead cells (propidium iodide), and analyzed by fluorescence microscopy. Cell adhesion, growth and morphology were assessed by brightfield and fluorescence microscopy.

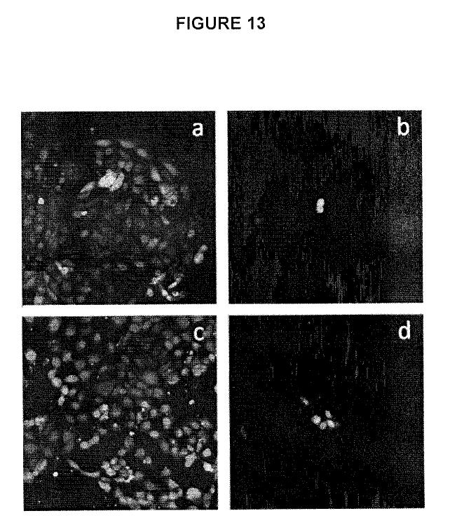

FIG. 13 shows images of adhered cells for the substrates/films incubated with cells after approximately 72 h of incubation. Cells on both the control untreated glass substrate (FIG. 13a) and RGD-modified PEG acrylate films (FIG. 13c) show, over 72 h, an average of 250 and 148 cells per mm², respectively. Cells on these surfaces have an elongated or flattened profile, exhibiting typical epithelial morphology. This indicates that the RGD-functionalized PEG films performed equivalent to glass in facilitating the adhesion of cells.

In contrast, cells adhered onto unfunctionalised PEG acrylate films (FIG. 13b) and RAD-modified PEG acrylate films (FIG. 13d) are round, which is indicative of poor cell adhesion. Furthermore, cells are present in relatively few numbers with an average of 14 and 10 cells per mm² over 72 h for the PEG- and RAD-modified PEG acrylate films, respectively.

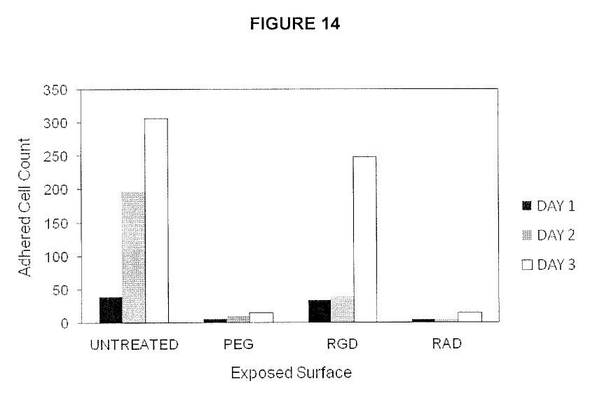

An understanding of the interaction and growth of cells on the different surface types was further obtained by counting the cells from microscopy images (FIG. 14). A steady growth of cells was observed on the control untreated glass surface over 72 h. In contrast, only a slight increase in the number of cells was seen for the unfunctionalised PEG films, demonstrating the ability of the PEG multilayers to resist the adhesion of anchorage-dependent cells. These low-biofouling PEG acrylate films were transformed to a surface promoting specific cell adhesion and growth by functionalization with an RGD peptide. The RGD functionalised films show, on average, twelve-fold and nine-fold more adhered cells than RAD-functionalized PEG acrylate films and unfunctionalised PEG acrylate films, respectively. Furthermore, cells adhered to RGD-functionalized multilayers showed an eight-fold increase in number from 24 to 72 h, whereas the few cells on PEG films functionalized with RAD showed only a four-fold increase. This indicates that the RGD containing sequence immobilized onto the (PEG-Alk/PEG-Az)₅ films promoted the growth of the epithelial cells.

### Example 13

### Poly(PEG Acrylate) Based Nanoporous Polymer Spheres (PEG-NPS)

Halogen terminated PEG acrylate and click functionalised PEG_{Az} and PEGₐₗₖ were prepared in accordance with the procedure described in Example 7.

The azide and alkyne linkers shown below were synthesised in accordance with the procedures described in Journal of Organic Chemistry, 2003, 69, 609 and Tetrahedron Letters, 1998, 39, 3319.

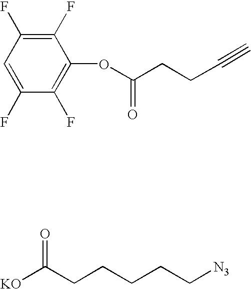

### (a) MS Sphere Modification

PEG-NPS were prepared in accordance with the procedure described in Example 7 for the preparation of PAA-NPS, however the click functionalities were grafted onto amine-functionalized MS spheres by incubating 5 mg of MS spheres with 5 mL of azide (1 mg mL⁻¹ in DI water) or alkyne (1 mg mL⁻¹ in ethanol) linkers overnight in room temperature. This produces azide-functionalized MS (MS_{Az}) and alkyne-functionalized MS (MS_{Alk}), respectively. These particles were subjected to three centrifugation/washing cycles in water before ensuing applications.

### (b) Polymer Loading

For PEG-based NPS, 1.5 mL of the PEG solution (1 mg mL⁻¹) was gently shaken with 1.5 mg of the MS spheres for 8 h to achieve pore saturation, followed by the addition of 0.5 mL each of copper sulphate and sodium ascorbate, which induced the click immobilization of PEG into pore channels. The click reaction was allowed to proceed for a further 8 h before three centrifugation/washing cycles in water was performed.

### (c) Cross-Linking Via Click Chemistry

1.5 mL of BASED was added to an equivalent of 1.5 mg MS spheres. The incubation was allowed to proceed for at least 8 h. This was followed by the addition of 0.5 mL each of copper sulphate and sodium ascorbate. The click reaction was allowed to proceed for >2 h, followed by extensive centrifugation/washing cycles with pH 2HCl, DI water, ethanol and/or DMF.

### (d) MS Template Dissolution

MS templates were dissolved by exposure to ammonium fluoride (NH₄F)-buffered hydrofluoric acid (HF). Briefly, 10 μL of modified MS spheres (˜0.2 mg of starting MS template) were shaken with 10 μL of 2 M HF/8 M NH₄F for 120 s. The resulting click NPS were then collected after at least 3 centrifugation/water washing cycles. PAA-based NPS were centrifuged at 500 g for 5 min, while other click NPS were centrifuged at 30 g for 10 min.

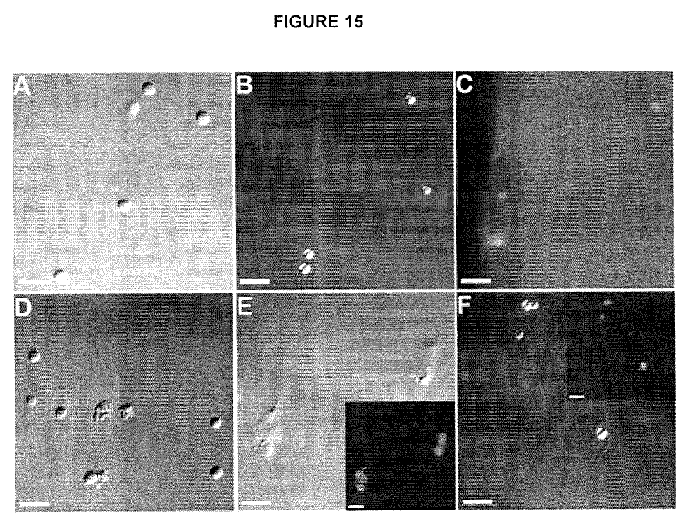

The first step in the process of assembling PEG-NPS entails the diffusion and immobilization (i.e., loading) of PEG into MS pore channels. The loading process is driven by the click-mediated immobilization of click functionalized PEG into complementarily click functionalized MS spheres. Synthesis of the PEG-NPS was based on the complementary pairing of alkyne functionalized poly(ethylene glycol acrylate) (PEG_{Alk}) and azide functionalized MS spheres (MS_{Az}). A ‘gapped’ loading procedure (i.e. incubation for 8 h, followed by catalyst addition, and a further 8 h of incubation) was used to prepare PEG_{Alk}-loaded MS_{Az} (PEG-MS) precursors (FIG. 15A), followed by the cross-linking of the PEG_{Alk} network with BASED to provide structural strength to the ensuing PEG-NPS. An advantage of the use of BASED is that this cross-linker provides a biologically-activated mechanism to disassemble the PEG_{Alk} network.

As BASED is insoluble in aqueous conditions cross-linking was performed in a 3:2 mixture of dimethyl sulfoxide (DMSO) and deionized (DI) water, in the presence of Cu(I) catalyst. FIG. 15B confirms the successful synthesis of BASED cross-linked PEG-NPS (PEG_{B}-NPS). Subsequent removal of MS template led to shrinkage of the PEG_{B}-NPS (˜30% in diameter).

### Example 14

### Doxorubicin (DOX) Functionalised PEG_{B}-NPS (DOX-PEG_{B}-NPS)

BASED crosslinked PEG-MS prepared in accordance with Example 13 were modified by attaching therapeutic doxorubicin (DOX) to the polymer. This experiment utilized the alkyne reservoir on PEG-MS for attachment of an azide functionalised DOX molecule (DOX_{Az}).

1.5 mL of DOX_{Az} was added to an equivalent of 1.5 mg PEG-MS spheres. The incubation was allowed to proceed for 15 min. This was followed by the addition of 0.5 mL each of copper sulphate and sodium ascorbate. The click reaction was allowed to proceed for 15 min for DOX_{Az}, followed by extensive centrifugation/washing cycles with pH 2HCl, DI water, ethanol and/or DMF.

DOX is a fluorescent anti-cancer compound. In this study, the DOX molecule employed was specifically engineered to have bifunctional properties, whereby a disulfide bridge connects the active portion of the molecule with an azide linker. Thus, a thiol-disulfide exchange can be used to cleave the active portion of DOX from the PEG_{Alk} network. The ability to selectively cleave the active portion of DOX means that a triggered cargo release mechanism has been engineered into the system. Attachment of DOX_{Az} was performed in a 3:2 mixture of N,N-dimethyl formamide (DMF) and deionized (DI) water, in the presence of Cu (I) catalyst. The presence of red fluorescence on PEG-MS confirmed the attachment of DOX_{Az} cargo.

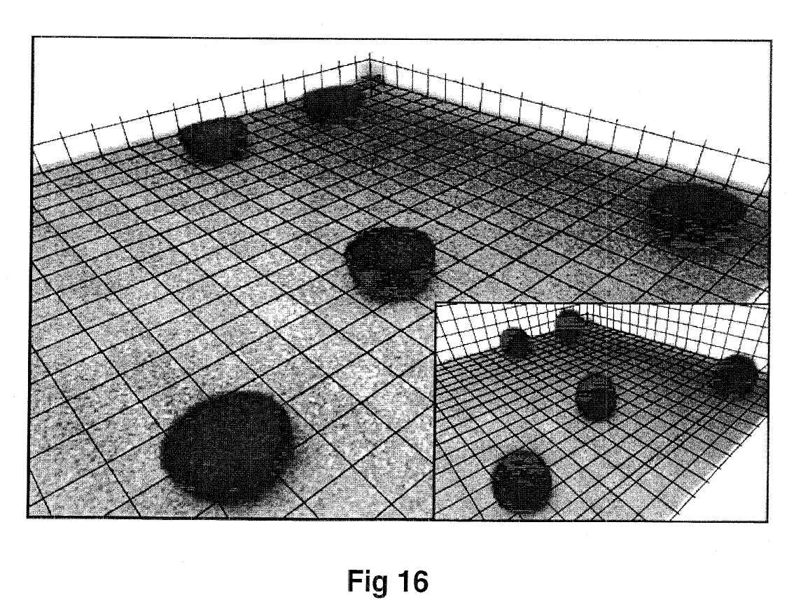

The DOX-functionalized PEG-MS was then exposed to NH₄F/HF to dissolve the MS template and yield DOX-functionalized PEG-NPS (DOX-PEG_{B}-NPS). Confocal scanning light microscopy (CLSM) dissection confirmed that DOX_{Az} was present throughout the interior and exterior of DOX-PEG_{B}-NPS (FIG. 16). The DOX-PEG_{B}-NPS exhibit similar physical properties to PEG-NPS in terms of size, stability, and dispersity. Importantly, DOX-PEG_{B}-NPS maintained its stability in phosphate buffer dispersion.

### Example 15

### Selective Release of Doxorubicin (DOX) from DOX-PEG_{B}-NPS

The drug delivery potential of the DOX-PEG_{B}-NPS system prepared in Example 14 was verified by incubating DOX-PEG_{B}-NPS with phosphate buffer containing a thiol-disulfide exchange reagent such as concentrated dithiothreitol (DTT) (20 mg mL−1), and physiological glutathione (GSH) (5 mM).

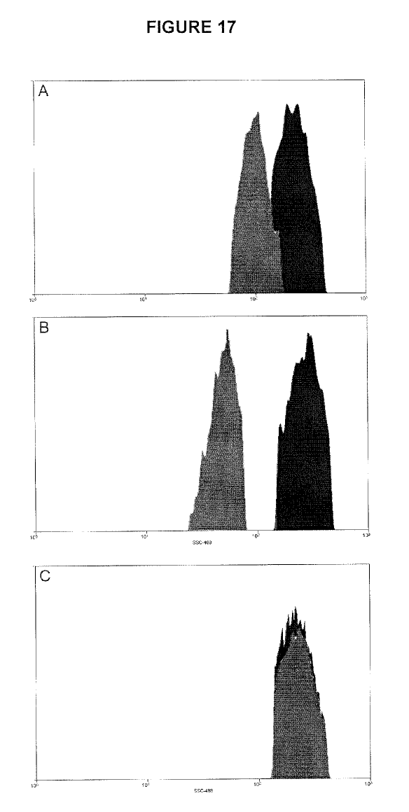

Direct optical observation on the DTT-incubated DOX-PEG_{B}-NPS after ˜1100 min was performed. FIG. 15C reveals a prominent increase in the bulk solution fluorescence, thus confirming the release of DOX from DOX-PEG_{B}-NPS. In addition, the flow cytometry scattering signal of DOX-PEG_{B}-NPS at the start and the end of this time-release study (FIG. 17A) reveals a substantial shift in the scattering signal after ˜1300 min incubation in DTT.

DOX released under physiological condition (5 mM GSH) was achieved over an extended period of time. Differential interference contrast (DIC) images taken after ˜70 h revealed the presence of disassembled particles, which provides strong evidence of DOX-PEG_{B}-NPS deconstruction (FIG. 15D). The structural change that resulted from the particle deconstruction is reflected in the dramatic shift in scattering signal (FIG. 17B).

After ˜340 h (2 weeks), with fresh GSH solution added intermittently, the DOX-PEG_{B}-NPS displayed vastly decreased structural integrity (FIG. 15E). Fluorescence microscopy inspection at this point reveals substantial amount of DOX retention (see inset FIG. 15E). This observation suggests that continued exposure to thiol-disulfide exchange reagent may sustain the release of DOX from its carrier beyond the investigation time frame. This may be useful for the sustained release of chemotherapy drugs such as DOX, as sustained release of the drug could replace the need for multiple administrations of the drug.

FIG. 15F reveals that particles incubated in phosphate buffer (no thiol reducing agent) for ˜340 h exhibit no evidence of particle deconstruction or DOX release. In addition, scattering signal confirms that the incubation in phosphate buffer did not alter the structure of DOX-PEG_{B}-NPS (FIG. 17C).

In comparison, particles incubated in phosphate buffer (no thiol reducing agent) for ˜340 h exhibited no evidence of particle deconstruction or DOX release. In addition, scattering signal confirmed that the incubation in phosphate buffer did not alter the structure of DOX-PEG_{B}-NPS (FIG. 17C).

### Example 16

### Poly(L-Lysine) (PLL) and poly(L-Glutamic Acid) (PGA) Multilayer Polymer Assemblies on Planar Support

Poly(L-lysine) (PLL) and poly(L-glutamic acid) based multilayer polymer assemblies were prepared from azide and alkyne functionalized poly(L-lysine) and poly(L-glutamic acid).

### (a) Preparation of Alkyne Functionalized Poly(L-Lysine) (PLL-Alk)

PLL with alkyne functionality (PLL-Alk) was synthesized via amide bond formation between the amine groups of lysine side chains and an activated ester of pentynoic acid (2,3,5,6-tetrafluorophenyl-pent-4-ynoate). 50 mg PLL were dissolved in 10 mL water and adjusted to pH 9.5 with hydrochloric acid. 9 mg of 2,3,5,6-tetrafluorophenyl-pent-4-ynoate in 5 mL ethanol were added and the clear solution was stirred at room temperature for 5 h. The product was dialyzed extensively against distilled water, freeze-dried to yield 45 mg of white polymer and analyzed using NMR spectroscopy (15% functionality). ¹H NMR (D₂O): 1.25-1.55 m & 1.55-1.85 m (CH_{α}(CH₂)₄NHCO polymer), 1.90 s (CCH click group) 2.38-2.52 dd (CH₂CCH click group), 2.90-3.10 bs (CH₂NHCO polymer), 3.15-3.25 m/t (NHCOCH₂ click group), 4.25-4.40 bs (CH_{α} polymer)

### (b) Preparation of Azide Functionalized Poly(L-Lysine) (PLL-Az)

PLL with azide functionality (PLL-Az) was synthesized via EDC mediated coupling of lysine moieties with 6-Azido-hexanoic acid potassium salt. 50 mg PLL were dissolved in 10 mL MilliQ water. 7 mg 6-Azido-hexanoic acid potassium salt and 46 mg EDC were added and the clear solution was stirred at room temperature for 5 h. The product was dialyzed and freeze-dried. 47 mg of white polymer were obtained and characterized using NMR spectroscopy (20% functionality). ¹H NMR (D₂O): 1.25-1.55 m & 1.55-1.85 m (CH_{α}(CH₂)₄NHCO polymer), 1.90 s (CCH click group) 2.38-2.52 dd (CH₂CCH click group), 2.90-3.10 bs (CH₂NHCO polymer), 3.15-3.25 m/t (NHCOCH₂ click group), 4.25-4.40 bs (CH, polymer)

### (c) Preparation of Fluorescently Labeled Alkyne Functionalized Poly(L-Lysine) (PLL-Alk_{RITC})

PLL-Alk was fluorescently labeled with Rhodamine β Isothiocyanate (RITC). A solution of PLL-Alk (2 mg mL¹, 1 eq.) in phosphate buffer (0.1 M, pH 7.5) was combined with a solution of RITC in DMSO (2 mg mL¹, 0.03 eq.) and stirred for 2 h. The product was dialyzed extensively and further purified using a Sephadex column. After freeze-drying a pink powder was obtained (PLL-Alk_{RITC}).

PLL-Az was fluorescently labeled with Alexa Fluor 488 N-Hydroxy-succinimidyl ester (NHS) following the same protocol. An orange paste (PLL-Az_{AF488}) was obtained after column purification and freeze-drying.

### (d) Preparation of Alkyne Functionalized Poly(L-Glutamic Acid) (PGA-Alk)

PGA with alkyne functionality (PGA-Alk) was synthesized via 4-(4,6-dimethoxy-1,3,5-triazin-2-yl)-4-methylmorpholinium chloride (DMTMM) mediated coupling of glutamic acid moieties with propargylamine. 30 mg PGA were dissolved in 10 mL MilliQ water. 3 mL propargylamine and 100 mg DMTMM were added and the yellow solution was stirred at room temperature for 5 h. After extensive dialysis against distilled water, the solution was filtered with a 0.2 μm syringe filter and freeze-dried to yield 25 mg of white polymer (15% functionality). ¹H NMR (D₂O). 1.25-1.55 m & 1.55-1.85 m (CH_{α}CH₂CH₂CH₂CH₂NHCO polymer), 1.90 s (CCH click group) 2.38-2.52 dd (CH₂CCH click group), 2.90-3.10 bs (CH₂NHCO polymer), 3.15-3.25 m/t (NHCOCH₂ click group), 4.25-4.40 bs (CH_{α} Polymer)

### (e) Preparation of Azide Functionalized Poly(L-Glutamic Acid) (PGA-Az)

PGA with azide functionality (PGA-Az) was synthesized via DMTMM mediated coupling of giutamic acid moieties with O-(2-Aminoethyl)-O′-(2-azidoethyl)pentaethylene glycol (H₂NPEG₅N₃). 30 mg PGA were dissolved in 10 mL water. 8 μL H₂NPEG₅N₃ and 100 mg DMTMM were added and the clear solution was stirred at room temperature for 5 h. After extensive dialysis against distilled water, the solution was filtered with a 0.2 μm syringe filter and freeze-dried to yield 25 mg of white polymer (10% functionality). ¹H NMR (D₂O): 1.25-1.55 m & 1.55-1.85 m (CH_{α}CH₂CH₂CH₂CH₂NHCO polymer), 1.90 s (CCH click group) 2.38-2.52 dd (CH₂CCH click group), 2.90-3.10 bs (CH₂NHCO polymer), 3.15-3.25 m/t (NHCOCH₂ click group), 4.25-4.40 bs (CH, polymer)

### (f) Preparation of Fluorescently Labeled Alkyne Functionalized Poly(L-Glutamic Acid)

PGA-Az was fluorescently labeled with click-functionalized Rhodamine β Isothiocyanate (RITC-Alkyne). A solution of PGA-Az (10 mg mL⁻¹) in water was mixed with 175 μL RITC-Alkyne in water (0.55 mg mL⁻¹). 1 mL of sodium ascorbate solution (16 mg mL⁻¹) and 1 mL of copper(II) sulfate solution (5 mg mL⁻¹) were added and the mixture was agitated for 2 h. The product was purified with a Sephadex column and after freeze-drying a pink powder was obtained.

### (g) Preparation of Multilayer Assemblies on Planar Support

Rectangular silicon wafer slides (20×5 mm²) were treated with a mixture containing 2 mL ethanol, 400 μL 3-Aminopropyltriethoxysilane (APTS) and 100 μL 28% ammonia solution for 2 h. The resulting “SiO₂⁺” slides were then rinsed with ethanol three times for a period of one minute respectively. Afterwards, slides were washed with water and slides were dried under a stream of nitrogen. An additional primer layer of PGA (1 mg mL⁻¹) was deposited by exposing the slides to the polymer solution for 20 min, followed by 3 water washes. For LbL assembly, APTS/PGA modified slides were sequentially immersed into solutions containing PLL-Az or PLL-Alk at the specified pH and salt concentrations shown in Table 1. Solutions contained the respective polymer (0.833 mg mL⁻¹), sodium chloride or water, sodium ascorbate (3.6 mg mL⁻¹) and copper sulfate (1.44 mg mL⁻¹) in a 6:2:1:1 volume ratio and will be referred to as “click solutions”. A period of 15 minutes was allowed for each layer deposition step, after which slides were rinsed with water three times for one minute and dried with nitrogen. Fresh solutions of copper sulfate were prepared every hour. Click solutions were prepared 5 min prior to application.

PLL and PGA were modified with azide and alkyne moieties using amide bond formation strategies. The degree of functionalization was approximately <20% as confirmed by NMR spectroscopy. The click-modified polymers were also fluorescently labeled to monitor the build-up of the multilayers and for imaging.

### (h) Characterization of PLL and PGA Multilayer Polymer Assemblies Formed on Planar Supports

The assembly of PLL click multilayer films on planar supports was investigated as a function of pH and salt concentration. Assembly of (PLL-Az/PLL-Alk)₅ multilayer films on APTS/PGA primed planar substrates at pH 7 and 0.5 M NaCl was found to be linear as determined by ellipsometry. The average layer thickness under these conditions was calculated to 0.94 nm.

Using the same procedure, poly(L-glutamic acid) (PGA) click multilayer films were also assembled on planar templates that had been primed with APTS to create a positive surface charge.

Table 1 summarizes the averaged values of thickness per click layer obtained by ellipsometry under the different conditions. In general, a greater individual layer thickness was found for films assembled at 0.5 M NaCl, showing that the addition of salt increased the amount of material deposited in multilayer assembly as charges are progressively shielded and polyelectrolytes adopt the more flexible random-coil conformation. Film thickness also increased towards higher pH values.

TABLE 1

| | | Average layer thickness (nm) | | |
|---|---|---|---|---|
| system | pH | (0 M NaCl) | (0.15 M NaCl) | (0.5 M NaCl) |
| PLL-Az/PLL-Alk | 7/7 | 0.4 | (x) | 0.94 |
| PLL-Az/PLL-Alk | 9/9 | 1.3 | (x) | 2.1 |
| PLL-Az/PLL-Alk | 5/9 | 2.4* | 2.9 | 4.5 |
| PGA-Az/PGA-Alk | 4/4 | — | — | 1.4* |

*system used for assembly on colloidal templates,
(x) = not carried out

### Example 17

### Core-Shell Particles Having Poly(L-Lysine) (PLL) and Poly(L-Glutamic Acid) (PGA) Multilayer Shell on Colloid Support

The preparation of functionalised poly(L-lysine) (PLL) and poly(L-glutamic acid) (PGA) were described in Example 16.

### (a) Preparation of PLL and PGA Core-Shell Particles on Colloidal Supports

100 μL of the particle stock solution (5 μm colloidal silica, 5 wt %) were washed with water and surface-modified in the same manner (APTS/PGA) as described above. Washing steps included the addition of 500 μL water to the particle suspension, which was then agitated for a short period to disperse the particles. After centrifugation for 1 minute at 1000 rcf, the supernatant was removed and the pellet redispersed in water. The washing procedure was repeated 3 times. The click-modified polymers were added sequentially, followed by 3 washes respectively, until the desired number of layers was reached.

Multilayer films made of (PLL-Az/PLL-Alk_{RITC})₆ were assembled on 5 μm colloidal templates. Film growth was found to be linear on unmodified silica as well as APTS/PGA primed templates. Better build-up was observed for the APTS/PGA primed system in comparison to unmodified silica templates.

Click-modified poly(-L-glutamic acid) (PGA) was assembled on APTS-primed colloidal templates. Linear build-up was also observed for this system.

### (b) PLL and PGA Capsule Formation

The colloidal silica core of the core-shell structures was dissolved away using hydrogen fluoride (HF) buffered to pH 5 with ammonium fluoride to yield PLL and PGA click capsules (hollow core-shell particles). PLL click capsules increased in size upon core removal, whereas the diameter of PGA click capsules decreased in comparison to the 5 μm core-shell particles. This suggests that the remaining amine and carboxylic acid moieties in the multilayer films are in their protonated (PGA) or deprotonated (PLL) form at this pH. For PLL, this may be due to electrostatic repulsion between the positively charged amine groups and subsequent swelling of the multilayer film and vice-versa for PGA click capsules. Several washing steps were applied to remove excess HF and isolate the capsules for analysis.

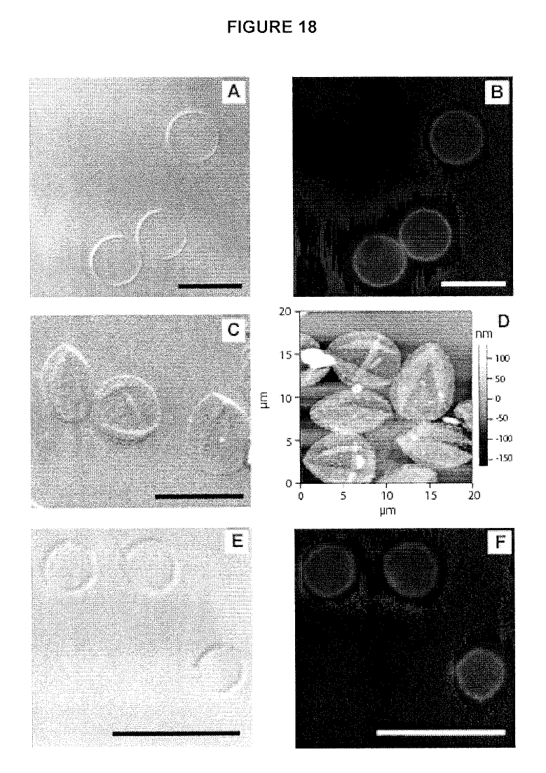

FIGS. 18a and 18b show a DIC and fluorescent image of PLL click capsules, respectively. A uniform coverage with fluorescently-labeled polymer, a regular spherical shape and uniform size of the capsules was observed. The SEM (FIG. 18c) and AFM (FIG. 18d) images show a smooth surface morphology. The capsules, although collapsed and folded, remained intact upon drying. The layer thickness of 2.2±0.2 nm extracted from AFM images is in good agreement with the ellipsometry results (for films assembled at pH 5/9 and 0 M NaCl).

FIGS. 18e and 18f show DIC and fluorescent images of PGA click capsules obtained after removal of the core. PGA click capsules are highly promising for biomedical applications, as PGA as a material is biodegradable as well as biocompatible.

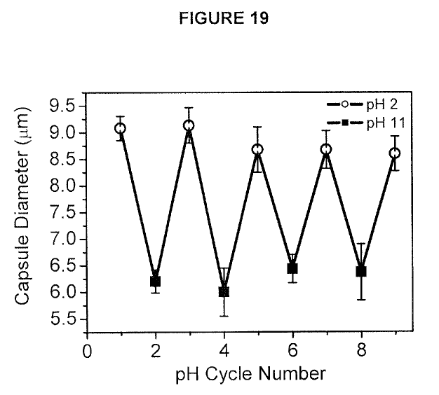

PLL click capsules were stable over a range of pH values (pH 2-11) and showed reversible pH-responsive swelling/shrinking behavior. Upon exposure to alternating pH 11 and pH 2, the PLL capsule diameter varied between about 6.0±0.5 μm and 9.1±0.3 μm by as much as 34% (FIG. 19). Hence, PLL click capsules swelled in pH 2 solutions and shrank if exposed to pH 11.

For PGA click capsules, capsule size varied between 4.0±0.6 μm at pH 2 and 5.1±0.3 μm in pH 11 solutions by as much as 21%. The pH-responsive shrinking/swelling behavior of the capsules is highly promising for use as a triggered loading/release mechanism.

### Example 18

### Poly(L-Lysine) Nanoporous Polymer Spheres (PLL-NPS)

### (a) Synthesis of Alkyne Click-Functionalized PLL (PLL_{Alk})

Alkyne-functionalized poly(L-lysine) (PLL_{Alk}) was synthesized via amide bond formation between lysine moieties and an activated ester of pentynoic acid, 2,3,5,6-tetrafluorophenyl-pent-4-noate. Briefly, 50 mg PLL (0.24 mmol lysine units, 1 eq.) were dissolved in 10 mL of deionized water and adjusted to pH 9.5 with 1 M HCl. 8.5 mg of 2,3,5,6-tetrafluorophenyl-pent-4-ynoate linker (0.024 mmol, 0.15 eq), dissolved in 5 mL ethanol, were added and the clear solution was stirred at room temperature for 5 h. The product was dialyzed for 36 h, followed by freeze-drying. PLL_{Alk} was characterized using NMR spectroscopy. The degree of functionalization was determined to be ˜15% by comparing the signal intensities of polymer (H_{α}=100%) and linker (NHCOCH₂).

### (b) Synthesis of Rhodamine Isothiocyanate Labeled PLL_{Alk} (RITC-PLL_{Alk})

PLL_{Alk} was fluorescently labeled with rhodamine β isothiocyanate (RITC). A solution of PLL_{Alk} (2 mg/mL, 1 eq.) in phosphate buffer (0.1 M, pH 7.5) was mixed with a solution of RITC in DMSO (2 mg/mL, 0.03 eq.) and stirred for 2 h. The product was dialyzed with Milli Q water for 48 h and further purified with a Sephadex column, followed by freeze drying.

### (c) Preparation of PLL-NPS

PLL is a weakly-charged cationic polypeptide. The electrostatic attraction between positively charged alkyne-functionalized PLL (PLL_{Alk}) and negatively charged MS₁₀₀ spheres was used to drive the adsorption and immobilization (i.e., loading) of PLL_{Alk} into MS pore channels.

Loading of the MS spheres using PLL_{Alk} solutions that contain 0.15 M NaCl at pH 7.0 was performed. The solution condition was chosen to simulate physiological condition to facilitate the fabrication of PLL thin films. The loading allowed to proceed for 8 h at an elevated temperature of 60° C.

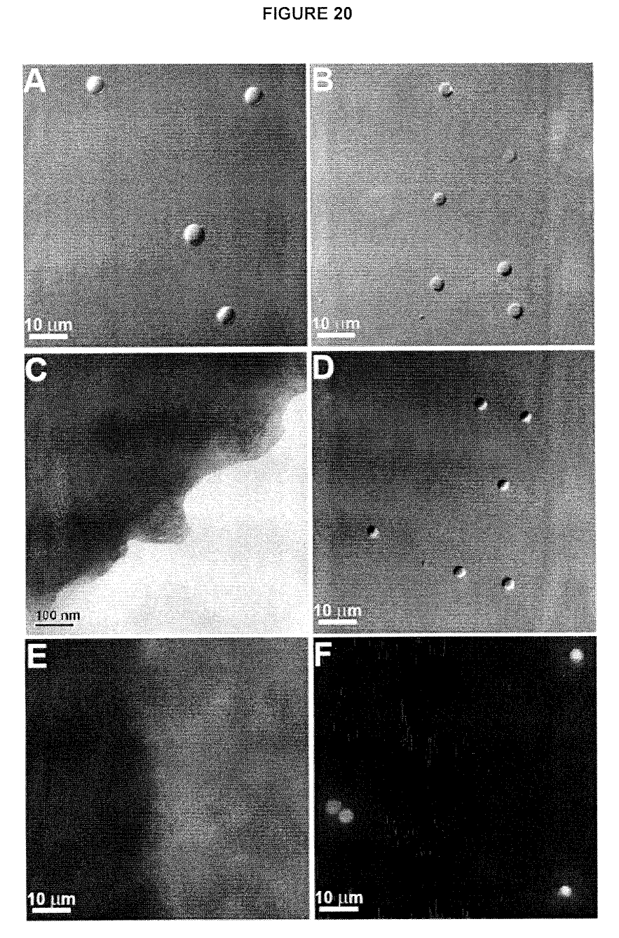

PLL_{Alk} loading followed by BASED cross-linking and MS₁₀₀ template removal in accordance procedures described above formed BASED cross-linked PLL-NPS (PLL_{B}-NPS) (FIGS. 20A and 20B).

### Example 19

### Selective Release of Rhodamine Isothiocyanate (RITC) from RITC-PLL_{B}-NPS

The potential of the BASED crosslinked PLL-NPS (PLL_{B}-NPS) to undergo selective degradation was then investigated.

Rhodamine isothiocyanate labeled PLL_{B}-NPS (RITC-PLL_{B}-NPS) prepared with rhodamine isothiocyanate labeled, alkyne functionalized poly(L-lysine) (RITC-PLL_{Alk}) were incubated in a relatively strong thiol-disulfide exchange reagent, 20 mg mL⁻¹ dithiothreitol (DTT), for 12 h. The triggered deconstruction of RITC-PLL_{B}-NPS is characterized by the release of RITC-PLL_{Alk} into the bulk solution. FIG. 20E revealed that prolonged exposure to DTT triggered substantial expulsion of RITC-PLL_{Alk} into the bulk solution. In a comparative experiment, RITC-PLL_{B}-NPS incubated for the same duration in phosphate buffer (no DTT) showed no evidence of RITC-PLL_{Alk} expulsion (FIG. 20F). The observations showed that destruction of the nanoporous particle could only occur in thiol-disulfide exchange environments.

It is understood that various other modifications and/or alterations may be made without departing from the spirit of the present invention as outlined herein.

1. A multilayer polymer assembly comprising:
(i) a plurality of polymer layers, the polymer layers forming one or more adjacent polymer layers; and
(ii) a plurality of crosslinks between at least one pair of adjacent polymer layers,
wherein each of the crosslinks comprise a cyclic moiety formed by a cycloaddition reaction.

2. An assembly according to claim 1 wherein each polymer layer of the assembly is crosslinked via a plurality of crosslinks to each polymer layer adjacent to it.

3. An assembly according to claim 1 wherein at least one polymer layer of the assembly is not crosslinked to each polymer layer adjacent to it.

4. An assembly according to claim 1 wherein the cyclic moiety is selected from the group consisting of tetrazoles, triazoles and oxazoles.

5. An assembly according to claim 4 wherein the cyclic moiety is a 1,2,3-triazole.

6. An assembly according to claim 1 wherein the crosslinks are formed by a cycloaddition reaction between complementary functional groups in the pair of adjacent polymer layers.

7. An assembly according to claim 6 wherein the complementary functional groups are paired functional groups selected from the group consisting of alkyne-azide, alkyne-nitrile oxide, nitrile-azide and maleimide-anthracene.

8. An assembly according to claim 1 wherein the crosslinks are formed by a cycloaddition reaction between functional groups in the pair of adjacent polymer layers and a crosslinking agent.

9. An assembly according to claim 1 wherein the crosslinks further comprises a cleavable moiety adapted to undergo selective degradation under pre-determined conditions.

10. An assembly according to claim 9 wherein the cleavable moiety degrades under hydrolytic, thermal, enzymatic, proteolytic or photolytic conditions.

11. An assembly according to claim 1 wherein each polymer layer comprises a polymer material independently selected from the group consisting of polymers, copolymer, polyelectrolyte polymers, polyethers, polyesters, polyalcohols, polyamides, biocompatible polymers, biodegradable polymers, polypeptides, polynucleotides, polycarbohydrates and lipopolymers.

12. A core-shell particle comprising a core and a shell material, wherein the shell material comprises: (i) a plurality of polymer layers, the polymer layers forming one or more pairs of adjacent polymer layers; and (ii) a plurality of crosslinks between at least one pair of adjacent polymer layers, wherein each crosslink comprises a cyclic moiety formed by a cycloaddition reaction.

13. A core-shell particle according to claim 12 which is a capsule.

14. A process for the preparation of a multilayer polymer assembly comprising:
(i) providing a polymer layer;
(ii) depositing a further polymer layer to form a pair of adjacent polymer layers; and
(iii) forming a plurality of crosslinks between the adjacent polymer layers,
wherein each crosslink comprises a cyclic moiety formed by a cycloaddition reaction.

15. A process according to claim 14 further comprising the step of:
(iv) depositing a polymer layer by a process selected from the group consisting of:
(a) depositing a polymer to form a pair of adjacent polymer layers, and forming a plurality of crosslinks between the pair of adjacent polymer layers, wherein each crosslink comprises a cyclic moiety from by a cycloaddition reaction; and
(b) depositing a polymer layer, wherein said polymer layer is not subsequently crosslinked to the polymer layer it is deposited on.

16. A process according to claim 15 wherein step (iv) is repeated a plurality of times.

17. A process according to claim 14 wherein the polymer layer of step (i) is provided on a substrate.

18. A process according to claim 17 wherein the substrate is a porous particle.

19. A process according to claim 17 wherein the substrate is removable.

20. A process according to claim 14 further comprising the step of modifying the multilayer polymer assembly by reacting at least one functional group of a polymer layer with a compound selected from the group consisting of antifouling agents, antimicrobials, chelating compounds, fluorescent compounds, antibodies, scavenging compounds, and physiologically active compounds.
